(19) United States
(12) Patent Application Publication
(10) Pub. No.: US 2026/0359035 A1
(43) Pub. Date: Nov. 12, 2026

(54) SYSTEMS AND METHODS FOR AUTOMATING ANALYSIS OF SOFTWARE DELIVERY

(71) Applicant: Fidelity Information Services, LLC, Jacksonville, FL (US)

(72) Inventor: Ranadhir GHOSH, St. Johns, FL (US)

(73) Assignee: Fidelity Information Services, LLC, Jacksonville, FL (US)

(21) Appl. No.: 19/673,703

(22) Filed: May 11, 2026

Related U.S. Application Data
(60) Provisional application No. 63/804,279, filed on May 12, 2025.

(51) Int. Cl. G06F 8/65; G06F 8/71

(52) U.S. Cl. CPC G06F 8/65; G06F 8/71

(57) ABSTRACT

A method may include receiving data with data values associated with a set of metrics from a plurality of software delivery tools that includes information related to at least one of issue tracking, version control, continuous integration and deployment (CI/CD) logs, incident management systems, or static code analysis; processing, by a processing agent, the received data to validate timestamps, normalize the data values for each metric of the set of metrics, and/or exclude invalid or duplicate data values; scoring, by a scoring agent, each metric of the set of metrics by comparing the processed data values for each metric to metric-specific scoring criteria; and generating, by an insights agent, actionable recommendations based on the scored set of metrics.

### CROSS-REFERENCE TO RELATED APPLICATIONS

This application claims priority to U.S. Application No. 63/804,279, filed May 12, 2025, which is hereby incorporated by reference in its entirety.

### TECHNICAL FIELD

Various embodiments of the present disclosure relate generally to automation systems and methods and, more particularly, to systems and methods for automating aspects of software delivery.

### BACKGROUND

Organizations face significant challenges when trying to improve the maturity of software delivery practices. Traditional approaches rely on suboptimal assessments, which can lead to a variety of issues including delays in delivery. Current systems use manual and time-consuming assessment processes and struggle to track progress. Moreover, current systems provide inconsistent evaluations and lack actionable insights. Without a standardized and automated approach, any assessment or evaluation is labor-intensive, subjective, and cannot update based on continuously changing data.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

In some aspects, the techniques described herein relate to a computer-implemented method for automating software delivery assessment, the method including: receiving, by one or more processors, data from a plurality of software delivery tools, the data including information related to at least one of issue tracking, version control, continuous integration and deployment (CI/CD) logs, incident management systems, or static code analysis tools, the received data including data values associated with a set of metrics; processing, by a processing agent executed by the one or more processors, the received data to validate timestamps, normalize the data values for each metric of the set of metrics, and/or exclude invalid or duplicate data values; scoring, by a scoring agent executed by the one or more processors, each metric of the set of metrics by comparing the processed data values for each metric to metric-specific scoring criteria; and generating, by an insights agent executed by the one or more processors, actionable recommendations based on the scored set of metrics.

In some aspects, the techniques described herein relate to a computer-implemented method, wherein the set of metrics includes metrics related to at least one of deployment frequency, lead time for changes, mean time to restore, change failure rate, cycle time, issue resolution time, code review effectiveness, pipeline success rate, code quality, or test coverage.

In some aspects, the techniques described herein relate to a computer-implemented method, further including: updating, by the one or more processors, scores for at least one metric of the set of metrics and the actionable recommendations over time based on newly collected data from the plurality of software delivery tools.

In some aspects, the techniques described herein relate to a computer-implemented method, wherein the scoring agent maps the normalized data values for each metric of the set of metrics to a corresponding level including at least two of a high level, a medium level, or a low level based on predefined thresholds.

In some aspects, the techniques described herein relate to a computer-implemented method, further including: generating, by the insights agent executed by the one or more processors, a report including strengths, weaknesses, and the actionable recommendations based on the scored set of metrics.

In some aspects, the techniques described herein relate to a computer-implemented method, further including: updating, by the one or more processors, the report over time based on newly collected data from the plurality of software delivery tools.

In some aspects, the techniques described herein relate to a computer-implemented method, wherein the report includes visualizations of trends over time and benchmark comparisons against industry standards.

In some aspects, the techniques described herein relate to a computer-implemented method, further including: training, by the one or more processors, a machine-learning model using historical metric data, user feedback, and benchmark performance targets to refine scoring accuracy of the scoring of the set of metrics and improve relevance of the actionable recommendations.

In some aspects, the techniques described herein relate to a computer-implemented method, wherein the data is collected by a data collection agent configured to integrate with APIs of at least one of Jira, GitHub, Jenkins, CI/CD pipelines, or static analysis tools.

In some aspects, the techniques described herein relate to a computer-implemented method, further including: coordinating, by a coordinator agent executed by the one or more processors, operations of the data collection agent, the processing agent, the scoring agent, and the insights agent.

In some aspects, the techniques described herein relate to a computer-implemented method, wherein the processing includes: applying, by the processing agent, a schema mapping operation that constructs a unified data schema and maps heterogeneous field names and data formats from each of the plurality of software delivery tools to corresponding fields in the unified data schema; validating timestamps and verifying integrity of the received data values; detecting and excluding duplicate data values by computing hash values for data records and comparing the hash values against previously stored hash values in a deduplication index; applying metric-specific normalization functions to scale the data values for each metric to enable comparison across metrics with different native units and value distributions; and associating additional metadata with the data values or aggregating data over specified time intervals.

In some aspects, the techniques described herein relate to a computer-implemented method, wherein the scoring includes: generating, by the scoring agent, an individual metric score for each metric of the set of metrics; constructing a multi-dimensional key performance indicator (KPI) vector for a given assessment period, wherein each dimension of the KPI vector corresponds to a normalized score for a respective metric of the set of metrics; accumulating a time series of KPI vectors across a plurality of assessment periods; applying a clustering algorithm to the time series of KPI vectors to partition the KPI vectors into a set of clusters, each cluster representing a distinct maturity profile; computing a centroid for each cluster representing a signature pattern and a frequency value representing a proportion of KPI vectors assigned to the cluster; assigning the given assessment period's KPI vector to a nearest cluster and outputting a corresponding maturity label; and computing a composite maturity score based on a weighted aggregation of the individual metric scores.

In some aspects, the techniques described herein relate to a computer-implemented method, wherein the generating of the actionable recommendations includes: receiving, by the insights agent, scored metric data and time series data from the scoring agent; computing a pairwise correlation matrix across the scored set of metrics for a defined historical window; identifying correlated metric pairs having a correlation coefficient exceeding a predefined correlation threshold; applying a trend detection algorithm to the time series data to detect at least one of an upward trend, a downward trend, or an anomaly for each metric; mapping combinations of the scored set of metrics, detected trends, and identified correlated metric pairs to a library of recommendation templates using a rule engine; populating matching recommendation templates with metric-specific values to generate the actionable recommendations; and ranking the actionable recommendations by a priority score based on at least one of a severity of an identified maturity gap, an estimated impact on a composite maturity score, or a confidence level of an underlying trend or correlation detection.

In some aspects, the techniques described herein relate to a computer-implemented method, further including: receiving, by the one or more processors, an actionable recommendation generated by the insights agent based on the scored set of metrics; evaluating a corrective action associated with the actionable recommendation to determine whether the corrective action is subject to a user-configurable approval policy; transmitting a control signal to one or more of the plurality of software delivery tools via an API integration to modify one or more configuration parameters of the one or more of the plurality of software delivery tools based on the corrective action; monitoring an effect of the corrective action on the scored set of metrics over a defined observation period; and evaluating an outcome of the corrective action by determining whether the scored set of metrics has improved, remained unchanged, or declined following the corrective action.

In some aspects, the techniques described herein relate to a system for automating software delivery assessment, the system including: a memory storing instructions and one or more AI agents; and one or more processors operatively connected to the memory and configured to execute the instructions to perform operations including: receiving data from a plurality of software delivery tools, the data including information related to at least one of issue tracking, version control, continuous integration and deployment (CI/CD) logs, incident management systems, or static code analysis tools, the received data including data values associated with a set of metrics; processing, by a processing AI agent of the one or more AI agents, the received data to validate timestamps, normalize the data values for each metric of the set of metrics, and/or exclude invalid or duplicate data values; scoring, by a scoring AI agent of the one or more AI agents, each metric of the set of metrics by comparing the processed data values for each metric to metric-specific scoring criteria; and generating, by an insights AI agent of the one or more AI agents, actionable recommendations based on the scored set of metrics.

In some aspects, the techniques described herein relate to a system, wherein the system supports real-time updates and is deployed as a cloud-based service.

In some aspects, the techniques described herein relate to a system, wherein the system is configured to receive user feedback on accuracy and usefulness of the actionable recommendations.

In some aspects, the techniques described herein relate to a system, the one or more processors operatively connected to the memory and configured to execute the instructions to perform the operations further including: training a machine-learning model using at least one of historical metric data, the user feedback, or benchmark performance targets to refine scoring accuracy of the scoring of the set of metrics and improve relevance of the actionable recommendations.

In some aspects, the techniques described herein relate to a system, wherein the machine-learning model automatically updates scoring and insight generation algorithms, based on at least one of the historical metric data, the user feedback, or the benchmark performance targets, utilized by the one or more AI agents to refine the scoring accuracy and improve the relevance.

In some aspects, the techniques described herein relate to a non-transitory machine-readable medium storing instructions that, when executed by one or more processors, cause a multi-agent generative AI system to perform a method for automating software delivery assessment, the method including: receiving data from a plurality of software delivery tools, the data including information related to at least one of issue tracking, version control, continuous integration and deployment (CI/CD) logs, incident management systems, or static code analysis tools, the received data including data values associated with a set of metrics; processing, by a processing agent, the received data to validate timestamps, normalize the data values for each metric of the set of metrics, and/or exclude invalid or duplicate data values; scoring, by a scoring AI agent, each metric of the set of metrics by comparing the processed data values for each metric to metric-specific scoring criteria; and generating, by an insights AI agent, actionable recommendations based on the scored set of metrics.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic of a multi-agent system, according to one or more embodiments.

FIG. 2 illustrates a diagram of agents, according to one or more embodiments.

FIG. 3 illustrates a diagram of exemplary metrics implemented by agents, according to one or more embodiments.

FIG. 4 is a flowchart showing a process for determining actionable recommendations, according to one or more embodiments.

FIG. 5 is a flowchart showing a data processing process, according to one or more embodiments.

FIG. 6 is a flowchart showing a method for computing a maturity score based on software delivery metrics, according to one or more embodiments.

FIG. 7 is a flowchart showing a process for generating actionable recommendations based on scored metric data, according to one or more embodiments.

FIG. 8 is a flowchart showing a process for determining actionable recommendations, according to one or more embodiments.

FIG. 9 is a flowchart showing a process for coordinating agent operations, according to one or more embodiments.

FIG. 10 illustrates a flow diagram for training a machine-learning model, according to one or more embodiments.

FIG. 11 illustrates an implementation of a computer system that executes techniques presented herein, according to one or more embodiments.

### DETAILED DESCRIPTION

Various embodiments of the present disclosure relate generally to intelligent software delivery assessment systems and, more particularly, to multi-agent AI architectures for automating collection, processing, scoring, and recommendation generation of software delivery metrics.

The present disclosure provides systems and methods for automatically assessing and improving software delivery practices within an organization. The disclosed technology employs multiple AI agents that work together to collect data from various software development tools, process and validate that data, score the data against established metrics, and generate actionable recommendations for improvement. Rather than relying on manual assessments that are time-consuming and prone to inconsistency, the system continuously gathers information from tools such as issue trackers, version control systems, CI/CD pipelines, and code analysis platforms. The system then evaluates key performance indicators including deployment frequency, lead time for changes, mean time to restore, and change failure rate, among others. Based on the scored metrics, the system identifies strengths and weaknesses in the software delivery process and provides targeted recommendations such as process improvements, tooling upgrades, or team practice suggestions. The system can also automatically execute corrective actions on the software delivery tools to address identified issues without requiring manual intervention. By leveraging machine learning, the system refines its scoring accuracy and recommendation relevance over time based on historical data, user feedback, and industry benchmarks.

As discussed above, organizations frequently face difficulties in accurately measuring and managing their software delivery maturity. Traditional maturity models rely on manually provided and outdated data to deliver relevant insights. These limitations can result in misaligned priorities between technical execution and strategic business outcomes. Conventional assessment approaches require significant human effort to collect data from disparate software delivery tools, including issue tracking systems, version control repositories, CI/CD pipelines, incident management platforms, and static code analysis tools. The manual nature of this data collection process introduces delays, inconsistencies, and errors that undermine the reliability of the resulting assessments. Furthermore, because the data is often collected at discrete intervals rather than continuously, the assessments quickly become stale and fail to reflect the current state of software delivery practices.

Another significant technical challenge with existing systems is the lack of standardized scoring criteria and the inability to normalize data values across heterogeneous software delivery tools. Different tools may represent similar metrics using different field names, data formats, timestamp conventions, and value ranges. Without automated schema mapping and normalization, comparing metrics across tools or aggregating metrics into a unified maturity assessment becomes error-prone and labor-intensive. Additionally, existing systems lack the capability to detect and exclude duplicate or invalid data values, which can skew the resulting scores and lead to inaccurate assessments. The absence of automated validation and deduplication mechanisms further compounds the reliability issues inherent in manual assessment processes.

Moreover, conventional systems fail to provide actionable recommendations that are tailored to the specific maturity gaps identified in the assessment. Even when assessments are completed, the resulting insights are often generic and do not account for the interdependencies between different metrics or the historical trends in the data. Without the ability to detect cross-metric correlations, identify statistically significant trends, or map scored metrics to specific remediation actions, organizations are left without clear guidance on how to improve their software delivery practices. The present disclosure addresses these technical challenges by providing a multi-agent AI architecture that automates the collection, processing, scoring, and recommendation generation of software delivery metrics, enabling continuous, standardized, and actionable maturity assessments.

The system, according to one or more embodiments of the present disclosure, overcomes these challenges through a generative AI-powered framework that leverages autonomous agents to collect, process, score, and evaluate key software delivery metrics across multiple tools and environments. As used herein, a generative AI system refers to a system that employs one or more generative machine-learning models, such as large language models, that are capable of generating new content including textual recommendations, reports, and insights based on learned patterns in the input data. The framework integrates with development and operations platforms (e.g., GitHub, Jira, continuous integration and deployment (CI/CD) pipelines, incident management systems, etc.) to continuously gather data and transform the data into scored outputs using standardized maturity criteria. Each agent in the system may specialize in specific responsibilities, such as data acquisition, processing, scoring, or insights generation. The system may dynamically adjust based on feedback or evolving metric definitions. To address the technical challenge of collecting data from disparate software delivery tools, the system may employ a data collection agent that interfaces directly with APIs of various platforms to extract raw data in a continuous and automated manner. This eliminates the delays and inconsistencies inherent in manual data collection processes and ensures that assessments reflect the current state of software delivery practices rather than stale snapshots collected at discrete intervals.

To address the technical challenge of normalizing data values across heterogeneous software delivery tools, the system employs a processing agent that applies schema mapping operations to construct a unified data schema. The processing agent may map heterogeneous field names, data formats, timestamp conventions, and value ranges from each software delivery tool to corresponding fields in the unified data schema. The processing agent may further detect and excludes duplicate or invalid data values by computing hash values for data records and comparing them against a deduplication index. By applying metric-specific normalization functions, the processing agent may scale data values for each metric to enable comparison across metrics with different native units and value distributions. This automated validation, deduplication, and normalization addresses the reliability issues inherent in manual assessment processes and ensures that downstream scoring is based on clean, consistent data.

To address the technical challenge of generating actionable recommendations tailored to specific maturity gaps, the system may employ a scoring agent and an insights agent that work in coordination. The scoring agent may compare processed data values for each metric to metric-specific scoring criteria and maps the results to tiered maturity levels. The insights agent may then analyze the scored metrics by computing pairwise correlation matrices to detect cross-metric correlations, applying trend detection algorithms to identify statistically significant patterns, and mapping combinations of scores, trends, and correlations to a library of recommendation templates using a rule engine. This may enable the system to generate prioritized, actionable recommendations that account for interdependencies between metrics and historical trends in the data. In some examples, the system may include a coordination layer implemented by a coordinator agent that coordinates agent workflows to ensure smooth execution from raw data intake to final maturity reporting. Implementing AI agents into the system may allow for the system to adapt scoring logic, processing rules, and/or insights generation based on human input or new patterns in data. This enables continuous improvement over time. The system further supports advanced analysis. For example, the system may apply a clustering method to multi-dimensional key performance indicator (KPI) vectors to create a signature pattern for each cluster with a frequency value. These insights empower organizations to proactively identify bottlenecks, reduce waste, and align software delivery practices with business goals. Additionally, by providing a consistent, repeatable framework for maturity evaluation, the system may optimize software delivery.

According to one or more embodiments, the system may provide technical advantages related to computational efficiency and resource utilization. By employing specialized AI agents that operate autonomously on dedicated tasks, the system may reduce the computational overhead associated with monolithic assessment processes. The data collection agent may minimize network bandwidth consumption by selectively retrieving only relevant data fields from software delivery tools rather than transferring entire datasets. The processing agent may reduce storage requirements by detecting and excluding duplicate data values before downstream processing occurs. The hash-based deduplication mechanism may enable efficient identification of duplicates without requiring computationally expensive pairwise comparisons across all data records. The metric-specific normalization functions may enable the scoring agent to process heterogeneous data formats without requiring manual data transformation, thereby reducing processing latency and enabling near real-time assessment updates.

According to one or more embodiments, the system may provide technical advantages related to assessment accuracy and reliability. The automated schema mapping operations performed by the processing agent may eliminate inconsistencies that arise when manually reconciling data from heterogeneous software delivery tools with different field names, data formats, and timestamp conventions. The validation mechanisms may detect and exclude invalid data values that would otherwise skew metric scores and lead to inaccurate maturity assessments. The clustering algorithms applied to multi-dimensional KPI vectors may identify signature maturity patterns that would not be apparent through manual analysis of individual metrics. The pairwise correlation matrix computations performed by the insights agent may detect cross-metric interdependencies that enable more accurate identification of root causes underlying observed maturity gaps.

According to one or more embodiments, the system may provide technical advantages related to adaptability and continuous improvement. The machine-learning models employed by the scoring agent and the insights agent may automatically refine scoring criteria and recommendation relevance based on historical metric data, user feedback, and benchmark performance targets. This adaptive capability may enable the system to improve assessment accuracy over time without requiring manual reconfiguration of scoring thresholds or recommendation templates. The closed-loop feedback mechanism that monitors the effect of corrective actions on scored metrics may enable the system to iteratively adjust corrective actions based on observed outcomes, thereby continuously optimizing software delivery practices. The coordinator agent may manage dependencies and parallel executions across agents to maintain system reliability and ensure efficient utilization of computational resources.

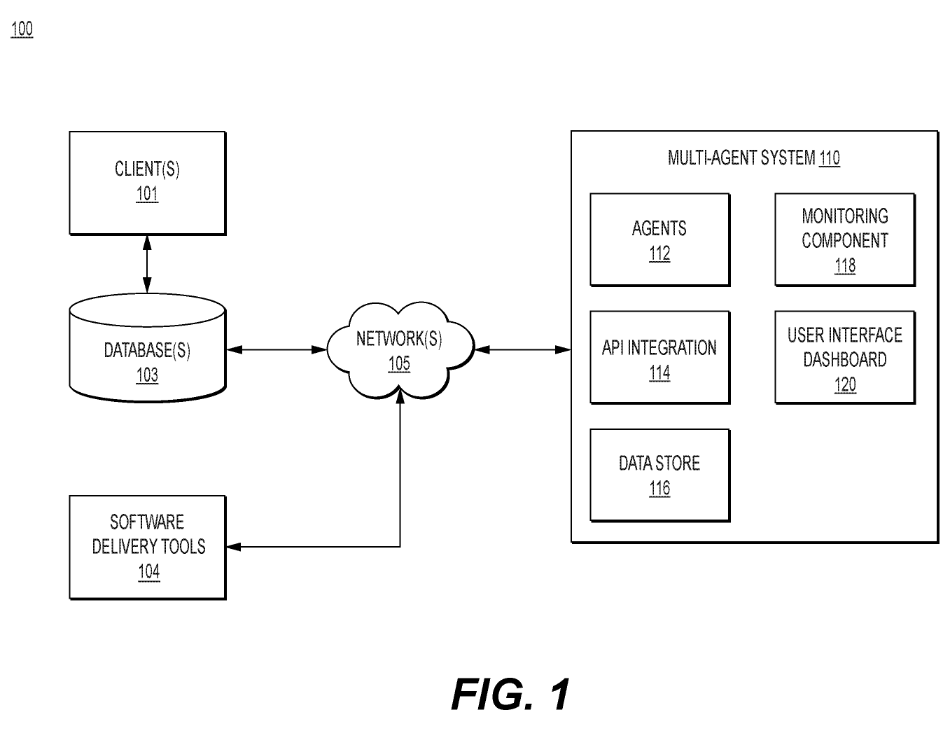

FIG. 1 illustrates a multi-agent system, according to one or more embodiments. As shown in FIG. 1, one or more databases 103 may be associated with (e.g., accessed by) one or more clients 101, and the multi-agent system 110 may be in communication with the one or more databases 103 through one or more networks 105.

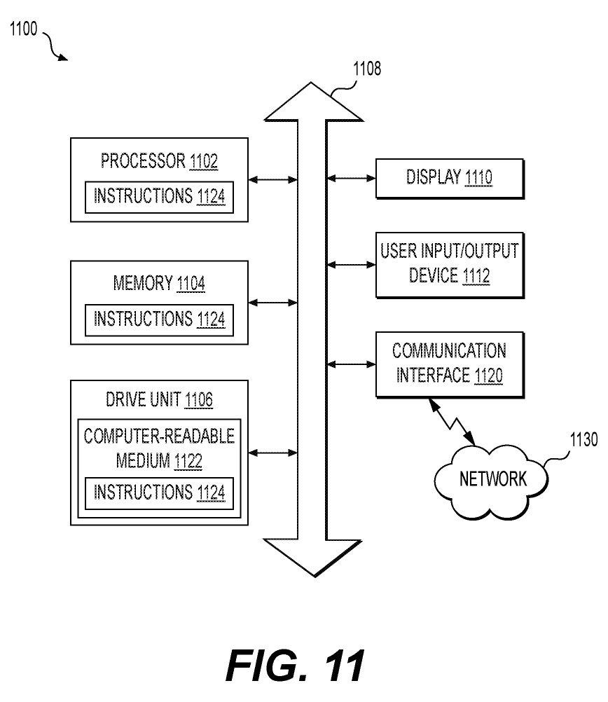

The one or more clients 101 may be individuals, companies, or other entities having an account with an enterprise, such as, for example, a financial institution, software provider, a healthcare company, etc. The one or more databases 103 may include any type of local, cloud, offline, or online database used by the one or more clients 101 to store data and provide data to the multi-agent system 110 via the one or more networks 105. The one or more databases 103 may be accessed by a client device, such as, for example, a mobile handset, a wireless communication device, a multimedia computer (e.g., computer system 1100, described below with reference to FIG. 11), an Internet-enabled node, a data server, or any instrument or tool that enables the one or more clients 101 to initiate connection with the one or more databases 103.

The one or more networks 105 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The one or more networks 105 may include wide area networks (WAN), such as the Internet, local area networks (LAN), campus area networks, metropolitan area networks, a direct connection such as through a Universal Serial Bus (USB) port, or any other networks that may allow for data communication. The one or more networks 105 may be configured to couple one computing device to another computing device to enable communication of data between the devices. The one or more networks 105 may generally be enabled to employ any form of machine-readable media for communicating information from one device to another. The one or more networks 105 may include communication methods by which information may travel between computing devices. The one or more networks 105 may be divided into sub-networks. The sub-networks may allow access to all the other components connected thereto or the sub-networks may restrict access between the components. The one or more networks 105 may be regarded as a public or private network connection and may include, for example, a virtual private network or an encryption or other security mechanism employed over the public Internet, or the like.

Referring to FIG. 1, the system 100 includes one or more clients 101, one or more databases 103, one or more networks 105, software delivery tools 104, and the multi-agent system 110. The one or more clients 101 may be individuals, companies, or other entities having an account with an enterprise, such as, for example, a financial institution, software provider, a healthcare company, etc. The one or more databases 103 may include any type of local, cloud, offline, or online database used by the one or more clients 101 to store data and provide data to the multi-agent system 110 via the one or more networks 105. The one or more databases 103 may be accessed by a client device, such as, for example, a mobile handset, a wireless communication device, a multimedia computer (e.g., computer system 1100, described below with reference to FIG. 11), an Internet-enabled node, a data server, or any instrument or tool that enables the one or more clients 101 to initiate connection with the one or more databases 103.

The one or more networks 105 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The one or more networks 105 may include wide area networks (WAN), such as the Internet, local area networks (LAN), campus area networks, metropolitan area networks, a direct connection such as through a Universal Serial Bus (USB) port, or any other networks that may allow for data communication. The one or more networks 105 may be configured to couple one computing device to another computing device to enable communication of data between the devices. The one or more networks 105 may generally be enabled to employ any form of machine-readable media for communicating information from one device to another. The one or more networks 105 may include communication methods by which information may travel between computing devices. The one or more networks 105 may be divided into sub-networks. The sub-networks may allow access to all the other components connected thereto or the sub-networks may restrict access between the components. The one or more networks 105 may be regarded as a public or private network connection and may include, for example, a virtual private network or an encryption or other security mechanism employed over the public Internet, or the like.

The multi-agent system 110 may be in communication with the one or more databases 103 and the software delivery tools 104 through the one or more networks 105. The multi-agent system 110 may include one or more agents 112, an API integration 114, a data store 116, a monitoring component 118, and a user interface dashboard 120. The one or more agents 112 may facilitate automated software delivery assessment by delegating responsibilities across one or more agents that may be AI agents. The API integration 114 enables the multi-agent system 110 to interface with external software delivery tools and platforms to collect data. The data store 116 provides storage for the data collected and processed by the multi-agent system 110, including metric data, scores, and historical information. The monitoring component 118 monitors the status and outputs of the agents 112 and the overall operation of the multi-agent system 110. The user interface dashboard 120 provides a display interface for presenting maturity scores, maturity insights, and maturity historical trends related to the set of metrics to users.

In some examples, each of the AI agents may incorporate a machine learning model such as a pre-trained large language model ("LLMs"). The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

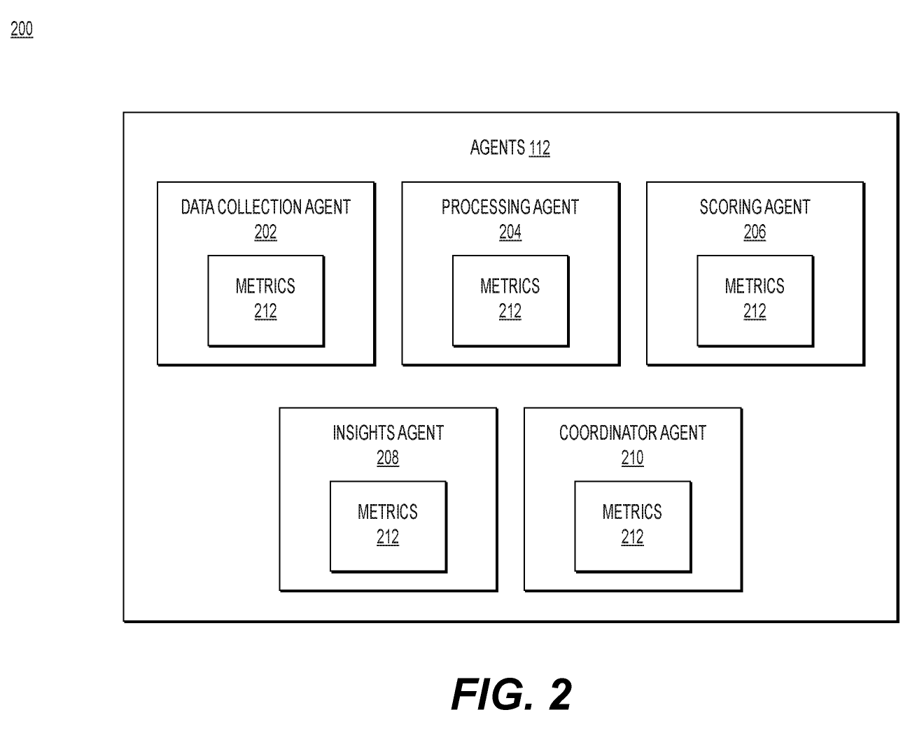

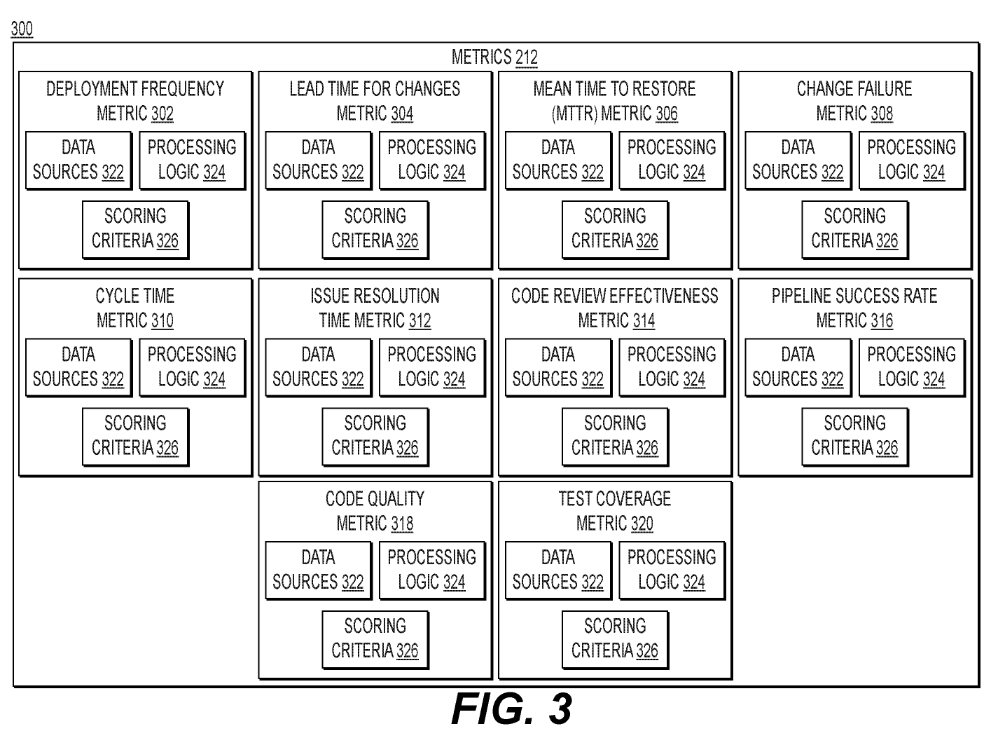

Referring to FIG. 2, the one or more agents 112 used by the multi-agent system 110 may include one or more of a data collection agent 202, a processing agent 204, a scoring agent 206, an insights agent 208, and a coordinator agent 210. An AI agent may refer to an autonomous, intelligent module configured to operate independently and to communicate and collaborate with one or more other agents. AI agents may be configured to execute particular tasks both asynchronously and/or synchronously. The one or more agents 112 may work collaboratively to streamline the flow of information from data acquisition through actionable insight generation. Each agent of the one or more agents 112 may operate autonomously on a dedicated task which contributes to the assessment pipeline. This, in turn, may enhance overall effectiveness in evaluating software delivery practices across an organization. Each AI agent may include tools, data, and/or a machine learning model. The tools may be configured to retrieve/receive data and implement a model to perform a particular function. Each agent may use a set of metrics 212 to perform their respective functions. The set of metrics 212 may include, for example, one or more of deployment frequency metric 302, lead time for changes metric 304, MTTR metric 306, change failure rate metric 308, cycle time metric 310, issue resolution time metric 312, code review effectiveness metric 314, pipeline success rate metric 316, code quality metric 318, and test coverage metric 320, as will be further described with respect to FIG. 3.

The data collection agent 202 may be responsible for receiving and/or retrieving raw data relevant to software delivery processes from a plurality of external software delivery tools, such as data found in the one or more databases 103. For example, the data collection agent 202 may operate via API integrations with tools commonly used for issue tracking, version control, CI/CD, incident management, and static code analysis. In an example, the data collection agent 202 may be configured to communicate with (e.g., integrate with the APIs of) platforms such as Jira, GitHub, Jenkins, CI/CD pipelines, and static analysis tools. These integrations may enable the data collection agent 202 to acquire raw data values that are associated with the set of metrics 212, which are metrics related to various parts of the software delivery lifecycle.

Specifically, the received data may include data values associated with the set of metrics 212 to evaluate software delivery maturity. The data collection agent 202 may tag each received data value with appropriate metadata, such as timestamps and metric-specific identifiers. As used herein, a structured data format refers to a data format in which data values are organized according to a predefined schema that defines field names, data types, and relationships between fields, such as JSON, XML, CSV, or a relational database table format. The received data may be formatted via the data collection agent 202 for proper downstream processing. The data collection agent 202 may associate the received data values with specific metrics of the set of metrics 212. In one or more embodiments, the data collection agent 202 may support continuous data retrieval. This may enable the multi-agent system 110 to dynamically update based on newly generated data from the integrated tools.

The processing agent 204 may be responsible for preparing the received data for metric scoring. For example, the processing agent 204 may validate, normalize, and/or remove the received data values associated with the set of metrics 212 for consistency across different data sources. This may include one or more of converting data formats, aligning timestamp conventions, validating timestamps, normalizing data values across different metrics, excluding invalid data values, excluding duplicate data values, and reconciling discrepancies in the structure of the data values across the software delivery tools. In an example, the processing agent 204 may flag duplicate or incomplete data values based on predefined validation rules. The processing logic used by the processing agent may be adaptable and designed to accommodate various data formats and schema discrepancies across tools. The processing agent may provide downstream agents data without undesired noise. The processing agent may also incorporate, via machine-learning models, dynamic adjustment mechanisms based on feedback or system configuration updates to further refine data handling. The processing agent may or may not be an AI model (e.g., an AI agent).

In some embodiments, the processing agent 204 may reconcile schema discrepancies across the plurality of software delivery tools by applying a schema mapping operation. As used herein, a schema mapping operation refers to a data transformation operation that maps field names, data types, and value formats from a source schema to corresponding fields in a target schema. The schema mapping operation may include constructing a unified data schema that defines a canonical set of field names, data types, and value ranges for each metric of the set of metrics 212. The processing agent 204 may then map heterogeneous field names and data formats from each software delivery tool to the corresponding fields in the unified data schema. For example, a first software delivery tool may represent deployment timestamps in Unix epoch format while a second software delivery tool may represent deployment timestamps in ISO 8601 format. The processing agent 204 may detect the format of each timestamp field by applying a pattern-matching operation against a library of known timestamp formats and convert each timestamp to a common format within the unified data schema. In another example, a first issue tracking system may label issue severity using numerical values (e.g., 1, 2, 3) while a second issue tracking system may label issue severity using textual labels (e.g., "critical," "major," "minor"). The processing agent 204 may apply a value mapping table to translate these heterogeneous representations into a normalized severity scale within the unified data schema.

In some embodiments, the processing agent 204 may detect and exclude duplicate data values by computing a hash value for each data record based on a combination of fields including at least a source identifier, a timestamp, and a metric identifier. The processing agent 204 may compare the computed hash value against a set of previously stored hash values in a deduplication index. If the computed hash value matches a previously stored hash value, the processing agent 204 may flag the data record as a duplicate and exclude it from downstream processing. This hash-based deduplication may enable the processing agent 204 to efficiently identify duplicates across data received from multiple software delivery tools without requiring pairwise comparison of all data records.

In some embodiments, the processing agent 204 may normalize the data values for each metric of the set of metrics 212 by applying a metric-specific normalization function. For example, for metrics that represent rates or percentages (e.g., change failure rate, test coverage, pipeline success rate), the processing agent 204 may apply a min-max normalization that scales the raw data values to a range between zero and one based on observed minimum and maximum values across a defined historical window. For metrics that represent durations (e.g., lead time for changes, MTTR, cycle time, issue resolution time), the processing agent 204 may apply a logarithmic transformation to compress the range of values and reduce the influence of outlier durations before normalizing to the zero-to-one range. For metrics that represent counts (e.g., deployment frequency), the processing agent 204 may apply a frequency-based normalization that divides the raw count by the length of the observation period to produce a rate value (e.g., deployments per day). The metric-specific normalization functions may enable the scoring agent 206 to compare scores across metrics that have different native units and value distributions.

In one or more embodiments, the processing agent 204 may operate in conjunction with the data collection agent 202 to properly categorize and structure each data value prior to being passed to the scoring agent 206. The processing agent 204 may modify the received data by, for example, associating additional metadata with the data values, aggregating data over specified time intervals, or computing intermediate values required for certain metrics.

The scoring agent 206 may generate metric scores based on the data values associated with each metric of the set of metrics 212. After receiving the data from the processing agent 204, the scoring agent 206 may apply one or more metric-specific scoring criteria to evaluate the maturity or performance of each corresponding metric. For example, as will be further described below, scoring criteria for one metric may differ from another metric. Each metric of the set of metrics 212 may be evaluated independently by the scoring agent 206 using scoring logic tailored to that metric's characteristics and relevance within the software delivery lifecycle. The metric-specific scoring criteria may be determined by a scoring criteria machine-learning model to adaptively improve the criterium. The scoring agent may map data values associated with a set of metrics (e.g., deployment frequency, lead time for changes, mean time to restore, change failure rate, etc.) to tiered maturity levels (e.g., high, medium, or low) based on predefined thresholds for each metric. The scoring agent may employ machine-learning techniques to refine scoring criteria based on historical trends, user feedback, or evolving industry benchmarks. The scoring agent may or may not be an AI model (e.g., an AI agent).

The scoring agent 206 may output a metric score for each individual metric based on how the received data values compare against the metric-specific scoring criteria. The metric-specific scoring criteria may include (e.g., be based on) predefined thresholds, industry benchmarks, and/or historical performance. For example, if the deployment frequency metric reflects 25 deployments per week, the scoring agent 206 may assign a score of 90 out of 100 based on that result's alignment with high-quality delivery performance. To compare scores across metrics, the scoring agent 206 may give a value based on a normalized scale out of 100 like the example above or a percentage out of 100%. The scoring agent 206 may then correlate (e.g., map) the determined score, or the normalized data values, to a specific tiered level such as high, medium, or low. Each metric score may represent a quantifiable output that feeds into downstream analysis within the multi-agent system 110, such as the insights agent 208 to determine actionable recommendations.

In some embodiments, the scoring agent 206 may construct a multi-dimensional KPI vector for a given assessment period, wherein each dimension of the KPI vector corresponds to a normalized score for a respective metric of the set of metrics 212. For example, if the set of metrics 212 includes ten metrics, the scoring agent 206 may construct a ten-dimensional KPI vector in which the first dimension corresponds to the normalized deployment frequency score, the second dimension corresponds to the normalized lead time for changes score, and so on for each metric. The scoring agent 206 may store a time series of KPI vectors, with each KPI vector corresponding to a respective assessment period, to enable temporal analysis of maturity trends.

In some embodiments, the scoring agent 206 may apply a clustering algorithm to a collection of KPI vectors to identify signature maturity patterns across assessment periods or across organizational units. For example, the scoring agent 206 may apply a k-means clustering algorithm to group the KPI vectors into k clusters, where each cluster represents a distinct maturity profile. The scoring agent 206 may compute a centroid for each cluster, wherein the centroid represents the signature pattern for that cluster. The scoring agent 206 may also compute a frequency value for each cluster representing the proportion of KPI vectors assigned to that cluster. The signature patterns and frequency values may enable the insights agent 208 to identify whether an organization's maturity profile is trending toward a higher-performing cluster or a lower-performing cluster over time.

In some embodiments, the scoring agent 206 may compute a composite maturity score by applying a weighted aggregation function to the individual metric scores. The weighted aggregation function may assign a weight to each metric based on at least one of a user-defined priority, a machine-learning-derived importance value, or a predefined industry benchmark weighting. The composite maturity score may be computed as a weighted sum of the individual metric scores, where each metric score is multiplied by its corresponding weight and the resulting products are summed and divided by the sum of the weights. The composite maturity score may provide a single scalar value that summarizes the overall software delivery maturity for a given assessment period.

The scoring agent 206 may include scoring logic to interpret the data values for each metric, to weight the scores and/or data values, to convert the scores into comparable results, etc. In some examples, the scoring agent 206 may generate flags for the insights agent 208 when certain metric scores fall below a threshold or deviate from an expected range. The scoring agent 206 may operate in real-time as new data is continuously processed such that the generated metric scores remain current and relevant. To better enable real-time updates, the multi-agent system 110 may be deployed as a cloud-based service. Additionally, the scoring agent 206 may iteratively update the scores provided based on historical metric data, user feedback, or benchmark performance targets. The scoring agent 206 may use a scoring algorithm to determine the scores for each metric.

The insights agent 208 may be responsible for analyzing the scores generated by the scoring agent 206 to identify relevant insights such as certain patterns or trends in one or more of the metrics in the set of metrics 212. The insights may then be used to provide actionable recommendations to a user or for the multi-agent system 110 to automatically update based on the actionable recommendations. The insights agent 208, to determine whether metric scores reflect good or poor performance, may apply heuristic rules, historical comparisons, or statistical models. In this way, the insights agent 208 may be able to determine healthy performance, declining trends, or anomalies in the software delivery process. For example, if the insights agent 208 detects a downward trend in deployment frequency alongside an upward trend in change failure rate, the insights agent 208 may provide an insight indicating potential issues in the release pipeline and accordingly generate an actionable recommendation to fix the problem. The insights agent 208 may also correlate multiple metric scores to derive more complex insights that consider the interdependencies between metrics. The insights agent may suggest next steps for delivery improvement, such as process changes, tooling upgrades, or targeted training. The insights agent may synthesize scores into actionable recommendations that support informed decision-making. Over time, the insights agent may adjust its recommendation models using collected user feedback and updated benchmarks. Iteratively improving the insights agent in this way may enhance the relevance and precision of the actionable recommendations the insights agent outputs. The insights agent may or may not be an AI model (e.g., an AI agent).

In some embodiments, the insights agent 208 may detect cross-metric correlations by computing a pairwise correlation matrix across the metric scores for a defined historical window. The pairwise correlation matrix may include a correlation coefficient for each pair of metrics in the set of metrics 212. The insights agent 208 may identify pairs of metrics having a correlation coefficient that exceeds a predefined correlation threshold (e.g., a positive correlation coefficient greater than 0.7 or a negative correlation coefficient less than -0.7) and generate a cross-metric insight indicating the detected correlation. For example, if the insights agent 208 detects a strong negative correlation between deployment frequency and change failure rate over a historical window, the insights agent 208 may generate an insight indicating that increasing deployment frequency without corresponding improvements in testing or quality gates may be contributing to an elevated failure rate. The cross-metric correlation analysis may enable the insights agent 208 to identify interdependencies between metrics that would not be apparent from analyzing each metric in isolation.

In some embodiments, the insights agent 208 may apply a trend detection algorithm to the time series of metric scores to identify statistically significant upward trends, downward trends, or anomalies. The trend detection algorithm may include computing a moving average and a moving standard deviation for each metric over a sliding window of assessment periods. The insights agent 208 may detect an anomaly when a metric score for a current assessment period deviates from the moving average by more than a predefined number of standard deviations (e.g., two standard deviations). The insights agent 208 may detect a trend when the slope of a linear regression fitted to the metric scores over the sliding window exceeds a predefined slope threshold. The insights agent 208 may generate a trend-based insight for each detected trend or anomaly, including a direction indicator (e.g., improving, declining, or anomalous), a magnitude indicator, and a confidence level based on the statistical significance of the detected pattern.

In some embodiments, the insights agent 208 may generate the actionable recommendations by applying a rule engine that maps combinations of metric scores, detected trends, and cross-metric correlations to a library of predefined recommendation templates. Each recommendation template may be associated with a set of trigger conditions defined over the metric scores, trends, and correlations. The insights agent 208 may evaluate the trigger conditions against the current metric scores, detected trends, and cross-metric correlations to identify matching recommendation templates. The insights agent 208 may then populate the matching recommendation templates with metric-specific values (e.g., the current score, the target score, the detected trend direction) to generate the actionable recommendations. In some examples, the insights agent 208 may rank the generated actionable recommendations by a priority score computed based on at least one of the severity of the identified maturity gap, the estimated impact of the recommendation on the composite maturity score, or the confidence level of the underlying trend or correlation detection.

In some embodiments, the insights agent 208 may provide confidence levels, severity indicators, or other metadata for each insight and/or actionable recommendation. For example, the actionable recommendations provided to the user may be sorted based on perceived importance or may indicate to the user how impactful the recommendation is perceived to be by the multi-agent system 110. In general, the insights and/or actionable recommendations may be formatted for display within a user interface (e.g., user interface dashboard 120) in a way that aids human interpretation.

In an example, a dashboard may present, to a user via a user interface (e.g., the user interface dashboard 120) prioritized insights with visual cues or suggested actions based on the insight content. The dashboard may display maturity scores, maturity insights, and/or maturity historical trends related to the set of metrics 212. In another example, the insights agent 208 may generate a report that includes strengths, weaknesses, and actionable recommendations based on the data values and scored metrics. The report, or any output provided by the insights agent 208, may include visualizations (e.g., graphs, charts, etc.) of trends over time and benchmark comparisons against industry standards. The insights agent 208 may support continuous evaluation, allowing insights to be updated dynamically as new metric scores are generated.

Additionally, the insights agent 208 may iteratively update the recommendations provided based on historical metric data, user feedback, or benchmark performance targets. For example, the output of the insights agent 208, such as the dashboard or the report described above, may be updated based on newly collected data from the software delivery tools. The actionable recommendations may include personalized next-step recommendations for the user to improve certain software delivery practices based on identified maturity gaps (e.g., gaps between the scoring of the metrics and the desired scores provided by the user and/or accessed by the multi-agent system 110). As used herein, a maturity gap refers to a difference between a current metric score or maturity level and a target metric score or maturity level, where the target may be defined by a user, derived from industry benchmarks, or determined by the machine-learning model. As used herein, a personalized recommendation refers to a recommendation that is tailored to the specific maturity gaps, metric scores, and historical trends of a particular organization or team, as opposed to a generic recommendation that applies uniformly regardless of the organization's current state. Additionally, the actionable recommendations may include at least one of targeted process improvements, tooling upgrades, or team practice suggestions. The insights agent 208 may use an insights algorithm to determine the insights and actionable recommendations. The insights algorithm may include the pairwise correlation matrix computation, the trend detection algorithm, and the rule engine mapping described herein. As used herein, an insight generation algorithm refers to a computational process that analyzes scored metric data to identify patterns, trends, correlations, and anomalies and maps the identified patterns to actionable recommendations.

The coordinator agent 210 may coordinate the activities of the other agents within the multi-agent system 110 to ensure efficient and synchronized operation. The coordinator agent 210 may manage the flow of data and tasks between one or more of the data collection agent 202, the processing agent 204, the scoring agent 206, and the insights agent 208. For example, the coordinator agent 210 may initiate data collection routines, trigger the execution of processing and scoring steps once data becomes available, and/or request insight generation based on newly computed metric scores. The coordinator agent 210 may monitor the status and outputs of each agent to detect failures, delays, or anomalies. The coordinator agent 210 may subsequently implement strategies as needed to maintain system reliability. The coordinator agent 210 may manage dependencies, retry logic, and parallel executions across agents.

In some embodiments, the coordinator agent may coordinate the execution of corrective actions across the plurality of software delivery tools. For example, when the insights agent generates an actionable recommendation that involves modifications to multiple software delivery tools (e.g., adjusting both a CI/CD pipeline configuration and an issue tracking workflow), the coordinator agent may sequence and synchronize the corrective actions to avoid conflicts or unintended interactions between the modifications. The coordinator agent may also manage rollback logic such that if a corrective action causes an unintended degradation in one or more metric scores, the coordinator agent may automatically reverse the corrective action and restore the previous configuration parameters of the affected software delivery tools.

As previously described, each of the agents described herein may include machine-learning models and, thus, may be AI agents. The multi-agent system 110 may generally utilize machine-learning models throughout the process of determining actionable recommendations. The machine-learning models described herein may not be explicitly associated with individual agents but rather used by more than one of the one or more agents 112. The machine-learning models may be trained using historical metric data, user feedback, and/or benchmark performance targets to refine scoring accuracy and improve relevance of the actionable recommendations, as described above with respect to the scoring agent 206 and the insights agent 208.

Referring to FIG. 3, the set of metrics 212 may include deployment frequency metric 302, lead time for changes metric 304, MTTR metric 306, change failure rate metric 308, cycle time metric 310, issue resolution time metric 312, code review effectiveness metric 314, pipeline success rate metric 316, code quality metric 318, and test coverage metric 320. Each metric includes data sources 322 that are used to provide relevant data, processing logic 324, and scoring criteria 326.

The deployment frequency metric 302 may include data related to how often code is deployed to a production environment within a defined time interval (e.g., daily, weekly, or monthly). Data sources 322 for the deployment frequency metric 302 may include CI/CD pipelines and deployment logs, which may be accessed by the data collection agent 202 via API integrations. The processing logic 324 for the deployment frequency metric 302 may validate the timestamps of deployment events and count the number of successful deployments within a selected timeframe. The scoring criteria 326 may classify deployment frequency into tiers: a high tier score may correspond to multiple deployments per day, a medium tier score may correspond to weekly deployments, and a low tier score may correspond to less than one deployment per month.

The lead time for changes metric 304 may include data related to the average time it takes for committed code to reach production through a successful deployment. Data sources 322 for the lead time for changes metric 304 may include GitHub, for commit timestamps, and CI/CD pipelines, for deployment timestamps. The data collection agent 202 may retrieve this data and the processing logic 324 may calculate the time difference between each commit timestamp and the associated deployment timestamp. The processing logic 324 may also exclude failed deployments from computations. The scoring criteria 326 may classify lead time for changes into tiers: a high tier score may correspond to a lead time less than one day, a medium tier score may correspond to a lead time between one and seven days, and a low tier score may correspond to a lead time greater than seven days.

The mean time to restore ("MTTR") metric 306 may include date related to the average time required to restore service after a failure. Data sources 322 for the MTTR metric 306 may include incident management platforms such as Jira, which provide incident detection and resolution timestamps, and CI/CD pipelines. The processing logic 324 may calculate the time between when an incident is detected and when the incident is resolved. Logs may be used to validate the detection and resolution timestamps. The scoring criteria 326 may classify MTTR into tiers: a high tier score may correspond to an MTTR that is less than one hour, a medium tier score may correspond to an MTTR that is between one and 12 hours, and a low tier score may correspond to an MTTR that is greater than 12 hours.

The change failure rate metric 308 may include data related to the percentage of changes (e.g., deployments) that fail and require remediation actions such as rollbacks or hotfixes. Data sources 322 for the change failure rate metric 308 may include CI/CD pipelines, which capture failed deployment events, and version control systems such as GitHub, which may log pull request rollback events. The processing logic 324 may calculate the failure rate as the percentage of failed deployments relative to total deployments, using the formula: (Failed Deployments/Total Deployments) × 100. Deployment logs may be used to validate failures using pipeline logs. The scoring criteria 326 may classify change failure rate into tiers: a high tier score may correspond to a failure rate of less than 15%, a medium tier score may correspond to a failure rate between 15% and 30%, and a low tier score may correspond to a failure rate greater than 30%.

The cycle time metric 310 may include data related to the total time taken to move a work item from initiation to deployment. That is, the cycle time metric 310 may track the time taken from work start (e.g., issue creation) to work completion (e.g., deployment). Data sources 322 for the cycle time metric 310 may include issue tracking systems such as Jira, which provide issue creation and resolution dates, as well as GitHub and CI/CD pipelines, which provide commit timestamps and deployment timestamps respectively. The processing logic 324 may calculate cycle time by measuring the time difference between the creation of an issue (e.g., a task or bug) and the corresponding deployment to production. Specifically, the processing logic 324 measures the time between the issue creation timestamp and the deployment timestamp. The scoring criteria 326 may classify cycle time into tiers: a high tier score may correspond to cycle times less than three days, a medium tier score may correspond to cycle times between three and 10 days, and a low tier score may correspond to cycle times greater than 10 days.

The issue resolution time metric 312 may include data related to the amount of time taken to resolve issues or support tickets, such as bugs or tasks. Data sources 322 for the issue resolution time metric 312 may include Jira or similar issue tracking systems, which provide issue creation timestamps and resolution creation timestamps. The processing logic 324 may calculate resolution time as the difference between the issue creation timestamp and the issue resolution timestamp. Invalid or duplicate issues may be excluded from consideration. The scoring criteria 326 may classify issue resolution time into tiers: a high tier score may correspond to resolution times under 24 hours, a medium tier score may correspond to resolution times between one and seven days, and a low tier score may correspond to resolution times greater than seven days.

The code review effectiveness metric 314 may include data related to the speed and thoroughness of peer code reviews (e.g., number of comments, review duration, etc.). Data sources 322 for the code review effectiveness metric 314 may include version control platforms such as GitHub, which provide pull request review comments and timestamps. The processing logic 324 may extract fields such as review_comments, reviewer_count, and time_to_approval (e.g., fields related to code reviews, such as comments, how many reviews, time to review, etc.) and may validate the review timelines. The scoring criteria 326 may classify code review effectiveness into tiers: a high tier score may correspond to pull requests that are reviewed within 24 hours and/or include high reviewer engagement (e.g., detailed comments), a medium tier score may correspond to reviews completed within two to three days, and a low tier score may correspond to reviews that take longer than three days and/or include minimal reviewer engagement (e.g., no comments).

The pipeline success rate metric 316 may include data related to the percentage of successful CI/CD pipeline executions over a given period. Data sources 322 for the pipeline success rate metric 316 may include CI/CD pipeline execution logs. The processing logic 324 may calculate the success rate by the following formula: (Successful Pipelines/Total Pipelines) × 100. Skipped or aborted pipelines may be excluded. The scoring criteria 326 may classify pipeline success rate into tiers: a high tier score may correspond to a success rate greater than 90%, a medium tier score may correspond to a success rate between 70% and 90%, and a low tier score may correspond to a success rate below 70%.

The code quality metric 318 may include data related to various indicators of code quality, such as, for example, technical debt, linting scores, and static analysis results. Data sources 322 for the code quality metric 318 may include static analysis tools such as SonarQube or ESLint. The processing logic 324 may normalize metrics such as the technical debt ratio (e.g., technical_debt_ratio) or linting errors (e.g., linting_errors). The scoring criteria 326 may classify code quality into tiers: a high tier score may correspond to minimal technical debt and a clean codebase, a medium tier score may correspond to moderate linting issues, and a low tier score may correspond to significant technical debt or numerous linting issues.

The test coverage metric 320 may include data related to the percentage of code that is covered by automated tests. Data sources 322 for the test coverage metric 320 may include outputs from automated testing frameworks such as Jest or PyTest, as well as CI/CD pipelines. The processing logic 324 may extract the test coverage percentage from these reports and validate the integrity of the test results. The scoring criteria 326 may classify scoring criteria into tiers: a high tier score may correspond to test coverage exceeding 80%, a medium tier score may correspond to test coverage between 50% and 80%, and a low tier score may correspond to test coverage below 50%.

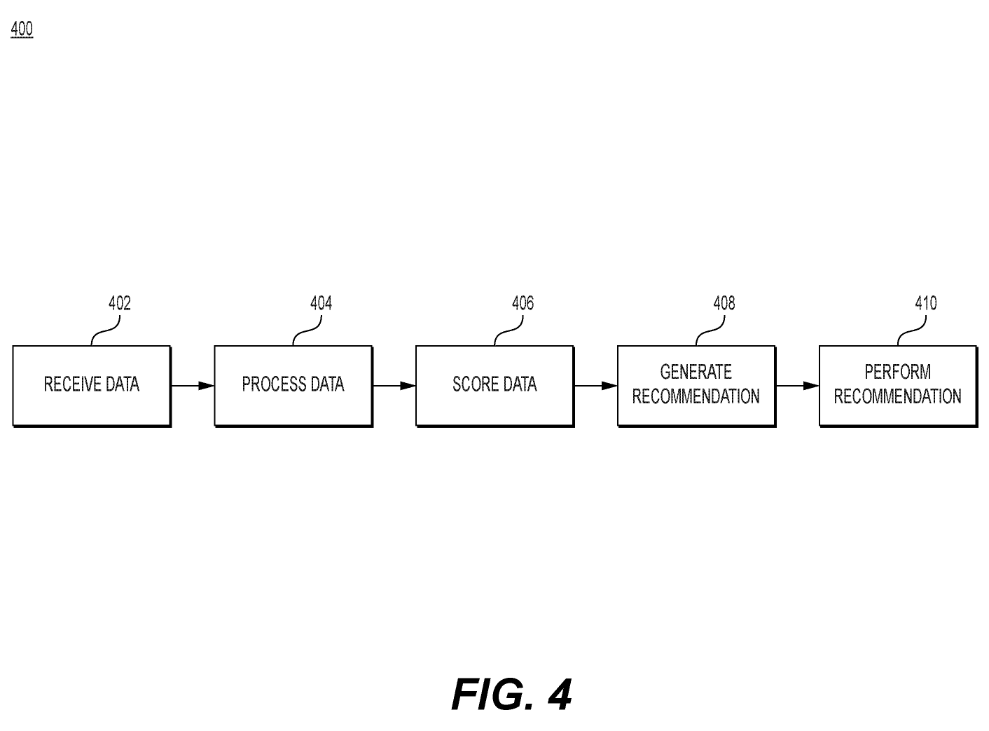

FIG. 4 illustrates a flowchart for a process 400 for determining actionable recommendations, according to one or more embodiments. In various embodiments, the multi-agent system 110 and/or one or more components thereof may perform one or more portions of the process 400. Although the process 400 is illustrated and described as a sequence of steps, various embodiments of the process 400 be performed in any order or combination, may omit one or more of the illustrated steps, and may include additional steps.

The process 400 may begin at a step 402, where the system may receive data. The data may include data values associated with a set of metrics from a plurality of software delivery tools. The data may include information related to at least one of issue tracking, version control, continuous integration and deployment (CI/CD) logs, incident management systems, or static code analysis tools. For example, the data collection agent 202 may receive data from the one or more databases 103 via API integrations with platforms such as Jira, GitHub, Jenkins, or static analysis tools. The received data may include data values associated with the set of metrics 212, such as deployment frequency, lead time for changes, mean time to restore, change failure rate, cycle time, issue resolution time, code review effectiveness, pipeline success rate, code quality, and test coverage.

At a step 404, the system may process the received data. The processing may include validating timestamps, normalizing the data values for each metric of the set of metrics, and excluding invalid or duplicate data values. For example, the processing agent 204 may apply schema mapping operations to construct a unified data schema and map heterogeneous field names and data formats from each software delivery tool to corresponding fields in the unified data schema. The processing agent 204 may detect and exclude duplicate data values by computing hash values for data records and comparing the hash values against previously stored hash values in a deduplication index. The processing agent 204 may also apply metric-specific normalization functions to scale the data values for each metric to enable comparison across metrics with different native units and value distributions.

At a step 406, the system may score the data. The scoring may involve comparing the processed data values for each metric to metric-specific scoring criteria. For example, the scoring agent 206 may evaluate each metric of the set of metrics 212 using scoring logic tailored to the characteristics of the metric. The scoring agent 206 may map the normalized data values for each metric to a corresponding level, such as a high level, a medium level, or a low level, based on predefined thresholds. The scoring agent 206 may also construct a multi-dimensional key performance indicator (KPI) vector for a given assessment period and compute a composite maturity score based on a weighted aggregation of the individual metric scores.

At a step 408, the system may generate a recommendation. The recommendation may be an actionable recommendation based on the scored set of metrics. For example, the insights agent 208 may analyze the scores generated by the scoring agent 206 to identify patterns, trends, or anomalies in the set of metrics 212. The insights agent 208 may compute a pairwise correlation matrix across the scored set of metrics to detect cross-metric correlations and apply a trend detection algorithm to identify statistically significant upward trends, downward trends, or anomalies. The insights agent 208 may map combinations of metric scores, detected trends, and cross-metric correlations to a library of recommendation templates using a rule engine to generate the actionable recommendations. The actionable recommendations may include at least one of targeted process improvements, tooling upgrades, or team practice suggestions.

At a step 410, the system may perform the recommendation. Performing the recommendation may include automatically executing corrective actions on one or more of the plurality of software delivery tools based on the actionable recommendations. For example, the insights agent 208 or the coordinator agent 210 may transmit one or more control signals to the plurality of software delivery tools via the API integration 114 to modify one or more configuration parameters of the software delivery tools without requiring manual intervention by a user. The corrective action may include automatically adjusting a CI/CD pipeline configuration parameter, modifying a workflow parameter in an issue tracking system, or adjusting a code quality gate or test coverage threshold in a static code analysis tool or testing framework. The system may subsequently monitor the effect of the corrective action on the scored set of metrics over a defined observation period and iteratively adjust the corrective action based on whether the scored set of metrics improves, remains unchanged, or declines following the corrective action.

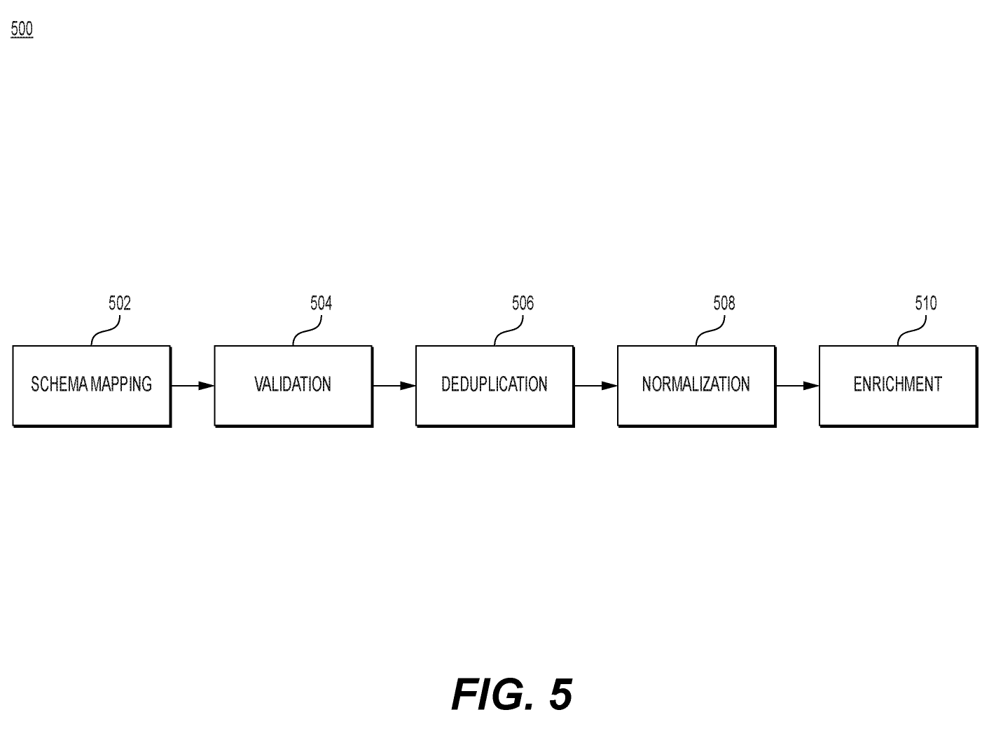

FIG. 5 illustrates a flowchart for a data processing process 500, according to one or more embodiments. The process 500 depicts a sequence of operations performed by the processing agent 204 to prepare received data for metric scoring. In various embodiments, the multi-agent system 110 and/or one or more components thereof may perform one or more portions of the process 500. Although the process 500 is illustrated and described as a sequence of steps, various embodiments of the process 500 may be performed in any order or combination, may omit one or more of the illustrated steps, and may include additional steps. Process 500 may be an exemplary method applied at step 404 described in FIG. 4.

The process 500 may begin at a step 502, which involves schema mapping. During the step 502, the processing agent 204 may construct a unified data schema and map heterogeneous field names and data formats from each software delivery tool to corresponding fields in the unified data schema. The unified data schema may define a canonical set of field names, data types, and value ranges for each metric of the set of metrics 212. For example, a first software delivery tool may represent deployment timestamps in Unix epoch format while a second software delivery tool may represent deployment timestamps in ISO 8601 format. The processing agent 204 may detect the format of each timestamp field by applying a pattern-matching operation against a library of known timestamp formats and convert each timestamp to a common format within the unified data schema. In another example, a first issue tracking system may label issue severity using numerical values while a second issue tracking system may label issue severity using textual labels. The processing agent 204 may apply a value mapping table to translate these heterogeneous representations into a normalized severity scale within the unified data schema.

At a step 504, the process 500 involves validation. During the step 504, the processing agent 204 may validate timestamps and verify the integrity of the received data values. The validation may include checking that timestamp values fall within expected ranges, verifying that data values conform to expected data types, and flagging data records that contain missing or malformed fields. The processing agent 204 may apply predefined validation rules to identify data values that do not meet integrity requirements. Data records that fail validation may be flagged for exclusion from downstream processing or may be logged for review.

At a step 506, the process 500 involves deduplication. During the step 506, the processing agent 204 may detect and exclude duplicate data values by computing hash values for data records and comparing the computed hash values against previously stored hash values in a deduplication index. The hash value for each data record may be computed based on a combination of fields including at least a source identifier, a timestamp, and a metric identifier. If the computed hash value matches a previously stored hash value in the deduplication index, the processing agent 204 may flag the data record as a duplicate and exclude the data record from downstream processing. The hash-based deduplication may enable the processing agent 204 to efficiently identify duplicates across data received from multiple software delivery tools without requiring pairwise comparison of all data records.

At a step 508, the process 500 involves normalization. During the step 508, the processing agent 204 may apply metric-specific normalization functions to scale the data values for each metric to enable comparison across metrics with different native units and value distributions. For metrics that represent rates or percentages (e.g., change failure rate, test coverage, pipeline success rate), the processing agent 204 may apply a min-max normalization that scales the raw data values to a range between zero and one based on observed minimum and maximum values across a defined historical window. For metrics that represent durations (e.g., lead time for changes, mean time to restore, cycle time, issue resolution time), the processing agent 204 may apply a logarithmic transformation to compress the range of values and reduce the influence of outlier durations before normalizing to the zero-to-one range. For metrics that represent counts (e.g., deployment frequency), the processing agent 204 may apply a frequency-based normalization that divides the raw count by the length of the observation period to produce a rate value (e.g., deployments per day). The metric-specific normalization functions may enable the scoring agent 206 to compare scores across metrics that have different native units and value distributions.

At a step 510, the process 500 involves enrichment. During the step 510, the processing agent 204 may associate additional metadata with the data values, aggregate data over specified time intervals, or compute intermediate values for certain metrics. The additional metadata may include source identifiers, collection timestamps, or metric-specific tags that facilitate downstream analysis. The aggregation may include computing summary statistics such as averages, medians, or percentiles over daily, weekly, or monthly intervals. The intermediate values may include computed ratios or derived metrics that are used by the scoring agent 206 during metric evaluation. The enrichment step 510 may prepare the processed data for downstream scoring by the scoring agent 206.

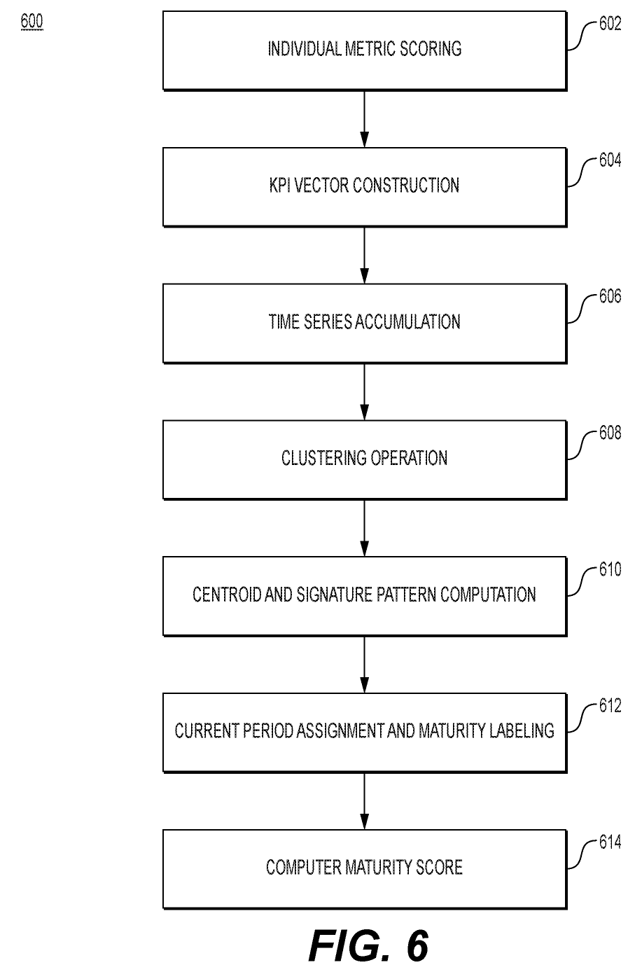

FIG. 6 illustrates a flowchart for a method 600 for computing a maturity score based on software delivery metrics, according to one or more embodiments. In various embodiments, the multi-agent system 110 and/or one or more components thereof may perform one or more portions of the method 600. Although the method 600 is illustrated and described as a sequence of steps, various embodiments of the method 600 may be performed in any order or combination, may omit one or more of the illustrated steps, and may include additional steps.

The method 600 may begin at a step 602, where individual metric scoring is performed. During the step 602, the scoring agent 206 may generate an individual metric score for each metric of the set of metrics 212. The scoring agent 206 may compare the processed data values for each metric to metric-specific scoring criteria and map the results to tiered maturity levels such as a high level, a medium level, or a low level based on predefined thresholds. The individual metric scores may represent quantifiable outputs that reflect the maturity or performance of each corresponding metric within the software delivery lifecycle.

At a step 604, the method 600 involves KPI vector construction. During the step 604, the scoring agent 206 may construct a multi-dimensional key performance indicator (KPI) vector for a given assessment period. Each dimension of the KPI vector may correspond to a normalized score for a respective metric of the set of metrics 212. For example, if the set of metrics 212 includes ten metrics, the scoring agent 206 may construct a ten-dimensional KPI vector in which a first dimension corresponds to a normalized deployment frequency score, a second dimension corresponds to a normalized lead time for changes score, and so on for each metric. The KPI vector may provide a unified representation of the software delivery maturity across multiple metrics for a given assessment period.

At a step 606, the method 600 involves time series accumulation. During the step 606, the scoring agent 206 may store a time series of KPI vectors, with each KPI vector corresponding to a respective assessment period. The time series accumulation may enable temporal analysis of maturity trends by preserving historical KPI vectors across multiple assessment periods. The accumulated time series of KPI vectors may be used by downstream steps to identify patterns, clusters, and trends in the software delivery maturity over time.

At a step 608, the method 600 involves a clustering operation. During the step 608, the scoring agent 206 may apply a clustering algorithm to the time series of KPI vectors to partition the KPI vectors into a set of clusters. Each cluster may represent a distinct maturity profile. For example, the scoring agent 206 may apply a k-means clustering algorithm to group the KPI vectors into k clusters, where each cluster corresponds to a different level or pattern of software delivery maturity. The clustering operation may enable the identification of signature maturity patterns across assessment periods or across organizational units.

At a step 610, the method 600 involves centroid and signature pattern computation. During the step 610, the scoring agent 206 may compute a centroid for each cluster, wherein the centroid represents a signature pattern for the cluster. The scoring agent 206 may also compute a frequency value for each cluster representing a proportion of KPI vectors assigned to the cluster. The signature patterns and frequency values may enable the insights agent 208 to identify whether an organization's maturity profile is trending toward a higher-performing cluster or a lower-performing cluster over time.

At a step 612, the method 600 involves current period assignment and maturity labeling. During the step 612, the scoring agent 206 may assign the KPI vector for the current assessment period to a nearest cluster based on a distance metric such as Euclidean distance between the current KPI vector and the cluster centroids. The scoring agent 206 may then output a corresponding maturity label associated with the assigned cluster. The maturity label may indicate the overall maturity profile of the software delivery practices for the current assessment period.

At a step 614, the method 600 involves computing a composite maturity score. During the step 614, the scoring agent 206 may compute the composite maturity score based on a weighted aggregation of the individual metric scores. The weighted aggregation function may assign a weight to each metric based on at least one of a user-defined priority, a machine-learning-derived importance value, or a predefined industry benchmark weighting. The composite maturity score may be computed as a weighted sum of the individual metric scores, where each metric score is multiplied by a corresponding weight and the resulting products are summed and divided by the sum of the weights. The composite maturity score may provide a single scalar value that summarizes the overall software delivery maturity for the given assessment period.

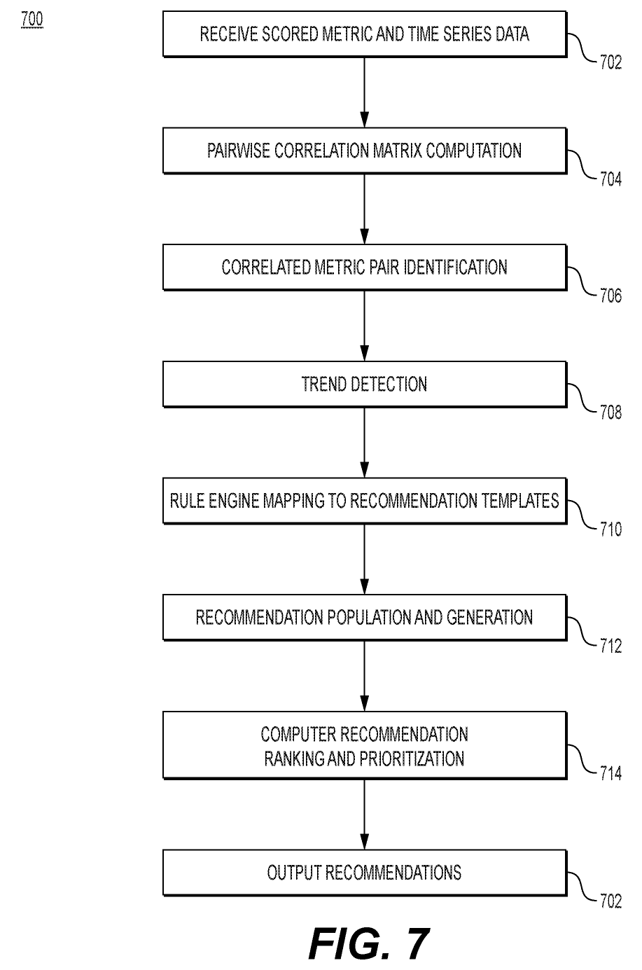

FIG. 7 illustrates a flowchart for a process 700 for generating actionable recommendations based on scored metric data, according to one or more embodiments. In various embodiments, the multi-agent system 110 and/or one or more components thereof may perform one or more portions of the process 700. Although the process 700 is illustrated and described as a sequence of steps, various embodiments of the process 700 may be performed in any order or combination, may omit one or more of the illustrated steps, and may include additional steps.

The process 700 may begin at a step 702, where the system receives scored metric and time series data. During the step 702, the insights agent 208 may receive scored metric data and time series data from the scoring agent 206. The scored metric data may include individual metric scores for each metric of the set of metrics 212, and the time series data may include historical KPI vectors accumulated across multiple assessment periods. The scored metric data and time series data may provide the inputs for downstream correlation analysis, trend detection, and recommendation generation.

At a step 704, the process 700 involves pairwise correlation matrix computation. During the step 704, the insights agent 208 may compute a pairwise correlation matrix across the scored set of metrics for a defined historical window. The pairwise correlation matrix may include a correlation coefficient for each pair of metrics in the set of metrics 212. The correlation coefficient may indicate the strength and direction of the relationship between two metrics over the historical window. For example, the insights agent 208 may compute a Pearson correlation coefficient or a Spearman rank correlation coefficient for each pair of metrics based on the time series of metric scores.

At a step 706, the process 700 involves correlated metric pair identification. During the step 706, the insights agent 208 may identify correlated metric pairs having a correlation coefficient that exceeds a predefined correlation threshold. For example, the insights agent 208 may identify pairs of metrics having a positive correlation coefficient greater than 0.7 or a negative correlation coefficient less than -0.7. The identified correlated metric pairs may indicate interdependencies between metrics that inform downstream recommendation generation. For example, if the insights agent 208 identifies a strong negative correlation between deployment frequency and change failure rate, the insights agent 208 may generate a cross-metric insight indicating that increasing deployment frequency without corresponding improvements in testing or quality gates may be contributing to an elevated failure rate.

At a step 708, the process 700 involves trend detection. During the step 708, the insights agent 208 may apply a trend detection algorithm to the time series data to detect at least one of an upward trend, a downward trend, or an anomaly for each metric. The trend detection algorithm may include computing a moving average and a moving standard deviation for each metric over a sliding window of assessment periods. The insights agent 208 may detect an anomaly when a metric score for a current assessment period deviates from the moving average by more than a predefined number of standard deviations (e.g., two standard deviations). The insights agent 208 may detect a trend when the slope of a linear regression fitted to the metric scores over the sliding window exceeds a predefined slope threshold. The insights agent 208 may generate a trend-based insight for each detected trend or anomaly, including a direction indicator (e.g., improving, declining, or anomalous), a magnitude indicator, and a confidence level based on the statistical significance of the detected pattern.

At a step 710, the process 700 involves rule engine mapping to recommendation templates. During the step 710, the insights agent 208 may apply a rule engine that maps combinations of the scored set of metrics, detected trends, and identified correlated metric pairs to a library of recommendation templates. Each recommendation template may be associated with a set of trigger conditions defined over the metric scores, trends, and correlations. The insights agent 208 may evaluate the trigger conditions against the current metric scores, detected trends, and cross-metric correlations to identify matching recommendation templates. For example, a recommendation template for improving deployment frequency may be triggered when the deployment frequency metric score falls below a predefined threshold and a declining trend is detected over the historical window.

At a step 712, the process 700 involves recommendation population and generation. During the step 712, the insights agent 208 may populate matching recommendation templates with metric-specific values to generate the actionable recommendations. The metric-specific values may include the current score, the target score, the detected trend direction, and the names of correlated metrics. For example, a recommendation template may include placeholder fields for the current deployment frequency score and the target deployment frequency score, and the insights agent 208 may populate the placeholder fields with the actual values to generate a recommendation such as "Increase deployment frequency from 2 deployments per week to 5 deployments per week." The populated recommendation templates may form the actionable recommendations output by the insights agent 208.

At a step 714, the process 700 involves recommendation ranking and prioritization. During the step 714, the insights agent 208 may rank the actionable recommendations by a priority score. The priority score may be computed based on at least one of a severity of an identified maturity gap, an estimated impact on a composite maturity score, or a confidence level of an underlying trend or correlation detection. For example, a recommendation addressing a metric with a low tier score and a declining trend may receive a higher priority score than a recommendation addressing a metric with a medium tier score and a stable trend. The ranked actionable recommendations may be presented to a user via the user interface dashboard 120 or may be used by the coordinator agent 210 to initiate corrective actions on the plurality of software delivery tools.

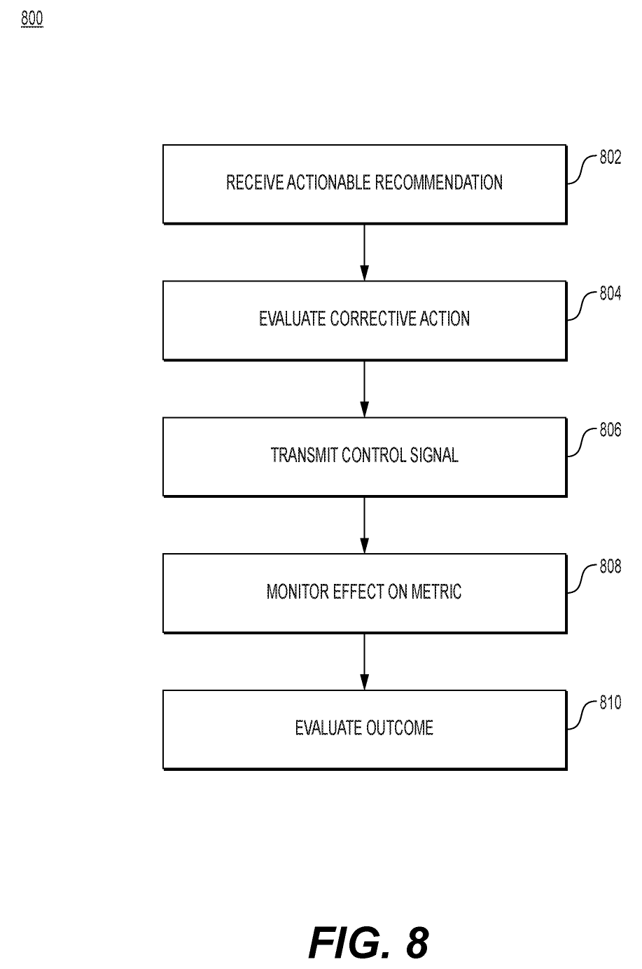

FIG. 8 illustrates a flowchart for a method 800 for automatically executing corrective actions based on actionable recommendations, according to one or more embodiments. In various embodiments, the multi-agent system 110 and/or one or more components thereof may perform one or more portions of the method 800. Although the method 800 is illustrated and described as a sequence of steps, various embodiments of the method 800 may be performed in any order or combination, may omit one or more of the illustrated steps, and may include additional steps.

The method 800 may begin at a step 802, where the system receives an actionable recommendation generated by the insights agent 208 based on the scored set of metrics. The actionable recommendation may include information identifying a corrective action to be performed on one or more of the plurality of software delivery tools. The corrective action may be associated with a maturity gap identified by the insights agent 208 during the analysis of the scored set of metrics 212. The actionable recommendation may further include metadata such as a priority score, a target metric, and a description of the corrective action.

At a step 804, the method 800 involves evaluating the corrective action associated with the actionable recommendation. During the step 804, the system may determine whether the corrective action is subject to a user-configurable approval policy. The approval policy may specify which types of corrective actions may be executed automatically without user approval and which types of corrective actions require user confirmation before execution. For example, a user may configure the system to automatically adjust deployment schedules and quality gate thresholds without approval, while requiring user confirmation before reassigning work items or modifying incident management workflows. The approval policy may be stored in the data store 116 and may be configurable via the user interface dashboard 120. If the corrective action requires user approval, the system may transmit a notification to the user via the user interface dashboard 120 and await confirmation before proceeding. If the corrective action may be executed automatically without user approval, the system may proceed to the next step.

At a step 806, the method 800 involves transmitting a control signal to one or more of the plurality of software delivery tools via the API integration 114 to modify one or more configuration parameters of the software delivery tools. The control signal may be transmitted to CI/CD pipeline tools, issue tracking systems, static code analysis tools, or testing frameworks depending on the nature of the corrective action. For example, if the corrective action involves adjusting a CI/CD pipeline configuration parameter, the system may transmit a control signal to a CI/CD pipeline tool (e.g., Jenkins) to modify a build trigger frequency, increase the cadence of automated deployment schedules, or adjust a deployment gate threshold. In another example, if the corrective action involves modifying a workflow parameter in an issue tracking system, the system may transmit a control signal to an issue tracking system (e.g., Jira) to re-prioritize work items, adjust work-in-progress limits, or reassign issues to different team members or queues. In another example, if the corrective action involves adjusting a code quality gate or test coverage threshold, the system may transmit a control signal to a static analysis tool (e.g., SonarQube) to tighten quality gate thresholds or to a testing framework (e.g., Jest or PyTest) to increase minimum test coverage requirements.

At a step 808, the method 800 involves monitoring the effect of the corrective action on the scored set of metrics over a defined observation period. During the step 808, the system may collect newly generated data from the plurality of software delivery tools via the data collection agent 202 and update the metric scores based on the newly collected data via the processing agent 204 and the scoring agent 206. The observation period may be a configurable time interval during which the system tracks changes in the scored set of metrics 212 following the execution of the corrective action. The monitoring component 118 may track the status of the corrective action and record the metric scores at intervals throughout the observation period.

At a step 810, the method 800 involves evaluating the outcome of the corrective action by determining whether the scored set of metrics has improved, remained unchanged, or declined following the corrective action. During the step 810, the system may compare the metric scores recorded during the observation period against the metric scores recorded prior to the execution of the corrective action. If the scored set of metrics has improved, the system may log the corrective action as successful and may apply similar corrective actions in response to future actionable recommendations addressing similar maturity gaps. If the scored set of metrics has remained unchanged or declined, the system may iteratively adjust the corrective action or take an alternative corrective action to address the identified maturity gap. For example, if the system automatically increases a deployment gate threshold and subsequently detects that the change failure rate metric score has not improved within the observation period, the system may further adjust the deployment gate threshold or take an alternative corrective action such as enabling additional automated testing stages in the CI/CD pipeline. The closed-loop feedback mechanism implemented by the method 800 may enable the system to continuously refine the corrective actions taken in response to the actionable recommendations.

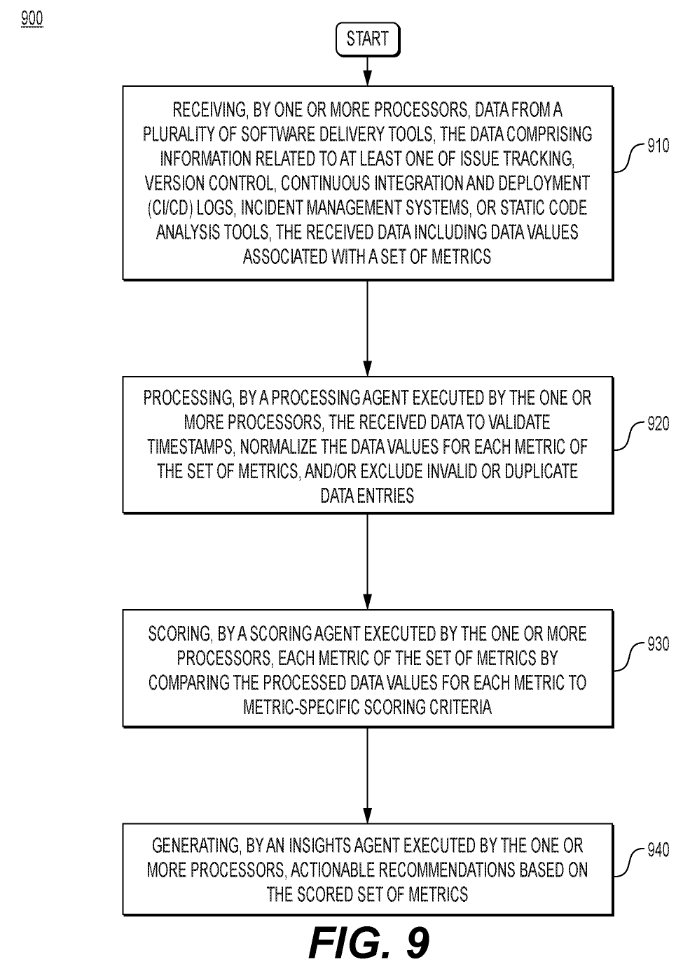

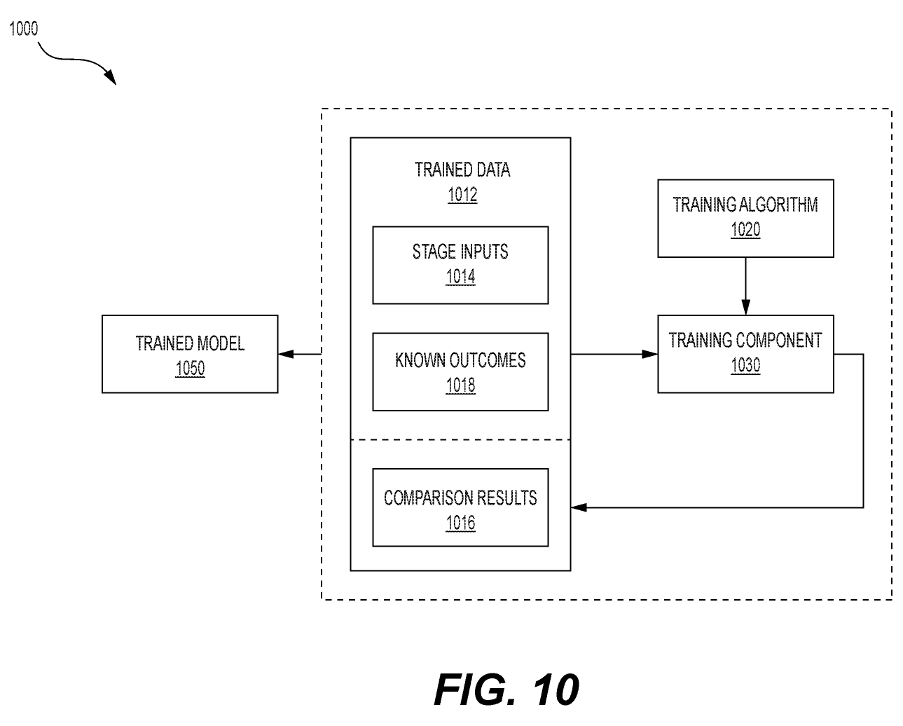

FIG. 9 is a flowchart showing a process for determining actionable recommendations, according to one or more embodiments. In various embodiments, the multi-agent system 110 and/or one or more components thereof may perform one or more portions of the process 900 and may be implemented using, for instance, a chip set including a processor and a memory as shown below in FIG. 10. As such, the multi-agent system 110 and/or any of components thereof may provide means for accomplishing various parts of the process 900, as well as means for accomplishing embodiments of other processes described herein in conjunction with other components of the multi-agent system 110. Although the process 900 is illustrated and described as a sequence of steps, it is contemplated that various embodiments of the process 900 are performed in any order or combination, need not include all of the illustrated steps, and may include additional or other steps.

In step 910, a system may receive data from a plurality of software delivery tools. The data may include data values associated with a set of metrics. The data may include information related to at least one of issue tracking, version control, CI/CD logs, incident management systems, or static code analysis tools. For example, the one or more agents 112 of the multi-agent system 110 may receive data from the one or more databases 103 associated with the one or more clients 101.

In step 920, the system may process the received data to validate timestamps, normalize the data values for each metric of the set of metrics, and/or exclude invalid or duplicate data values. For example, the processing agent of the one or more agents 112 may format and/or correct the data received for downstream components to analyze. Moreover, the processing agent may normalize data values associated with each metric of a set of metrics to enable downstream components to analyze and score each metric.

In step 930, the system may score each metric of the set of metrics by comparing the processed data values for each metric to metric-specific scoring criteria. The set of metrics may include one or more of deployment frequency, lead time for changes, mean time to restore (MTTR), change failure rate, cycle time, issue resolution time, code review effectiveness, pipeline success rate, code quality, and test coverage. Each metric may include relevant data values, processing logic, and scoring criteria as described in FIG. 3.

In step 940, the system may generate actionable recommendations based on the scored set of metrics. For example, an insights agent included in the one or more agents 112 used by the multi-agent system 110 may determine the best set of actions to take based on the score received for each metric. The insights agent may then subsequently provide the set of actions as recommendations for a user or for the system to automatically perform the recommendations and iteratively update in real-time.

In step 950, the system may automatically execute at least one corrective action on one or more of the plurality of software delivery tools based on the actionable recommendations. For example, the insights agent or the coordinator agent may transmit one or more control signals to the plurality of software delivery tools via the API integrations to modify one or more configuration parameters of the software delivery tools without requiring manual intervention by a user. The corrective action may be performed in real-time or near real-time in response to the generation of the actionable recommendations.

In some examples, the corrective action may include automatically adjusting a CI/CD pipeline configuration parameter based on the scored set of metrics. For example, if the scoring agent determines that the deployment frequency metric score falls below a predefined threshold (e.g., a low tier score corresponding to less than one deployment per month), the system may automatically transmit a control signal to a CI/CD pipeline tool (e.g., Jenkins) to modify a build trigger frequency, increase the cadence of automated deployment schedules, or adjust a deployment gate threshold to reduce bottlenecks in the release pipeline. In another example, if the change failure rate metric score exceeds a predefined threshold (e.g., a low tier score corresponding to a failure rate greater than 30%), the system may automatically transmit a control signal to a CI/CD pipeline tool to enable additional pre-deployment validation checks, activate a canary deployment strategy, or reduce the batch size of deployments to mitigate risk.

In some examples, the corrective action may include automatically modifying a workflow parameter in an issue tracking system. For example, if the cycle time metric score or the issue resolution time metric score falls below a predefined threshold, the system may automatically transmit a control signal to an issue tracking system (e.g., Jira) to re-prioritize work items, adjust work-in-progress limits, reassign issues to different team members or queues, or flag overdue items for escalation. In this way, the system may proactively address identified maturity gaps by adjusting the operational parameters of the software delivery tools rather than merely reporting the gaps to a user.

In some examples, the corrective action may include automatically adjusting a code quality gate or test coverage threshold in a static code analysis tool or testing framework. For example, if the code quality metric score or the test coverage metric score falls below a predefined threshold, the system may automatically transmit a control signal to a static analysis tool (e.g., SonarQube) to tighten quality gate thresholds, or to a testing framework (e.g., Jest or PyTest) to increase minimum test coverage requirements for builds to pass. By automatically adjusting these parameters, the system may enforce progressively higher quality standards as the organization's maturity improves.

In some examples, the system may automatically execute the corrective action and subsequently monitor the effect of the corrective action on the scored set of metrics over a defined observation period. The system may then iteratively adjust the corrective action based on whether the scored set of metrics improves, remains unchanged, or declines following the corrective action. This closed-loop feedback mechanism may enable the system to continuously refine the corrective actions taken in response to the actionable recommendations. For example, if the system automatically increases a deployment gate threshold and subsequently detects that the change failure rate metric score has not improved within the observation period, the system may further adjust the deployment gate threshold or take an alternative corrective action such as enabling additional automated testing stages in the CI/CD pipeline.

In some examples, the corrective action may be subject to a user-configurable approval policy. The approval policy may specify which types of corrective actions may be executed automatically without user approval and which types of corrective actions may require user confirmation before execution. For example, a user may configure the system to automatically adjust deployment schedules and quality gate thresholds without approval, while requiring user confirmation before reassigning work items or modifying incident management workflows. The approval policy may be stored in the memory and may be configurable via the user interface dashboard.

FIG. 10 depicts a flow diagram for training a machine-learning model, in accordance with an aspect of the disclosed subject matter. As shown in flow diagram 1000 of FIG. 10, training data 1012 may include one or more of stage inputs 1014 and known outcomes 1018 related to a machine-learning model to be trained. The stage inputs 1014 may be from any applicable source including a component or set shown in the figures provided herein. The known outcomes 1018 may be included for machine-learning models generated based on supervised or semi-supervised training. An unsupervised machine-learning model might not be trained using known outcomes 1018. Known outcomes 1018 may include known or desired outputs for future inputs similar to or in the same category as stage inputs 1014 that do not have corresponding known outputs.

The training data 1012 and a training algorithm 1020 may be provided to a training component 1030 that may apply the training data 1012 to the training algorithm 1020 to generate a trained machine-learning model 1050. According to an implementation, the training component 1030 may be provided comparison results 1016 that compare a previous output of the corresponding machine-learning model to apply the previous result to re-train the machine-learning model. The comparison results 1016 may be used by the training component 1030 to update the corresponding machine-learning model. The training algorithm 1020 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1000 may be a trained machine-learning model 1050. In some examples, the trained machine-learning model 1050 may be the machine learning model(s) utilized by the multi-agent system 110.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

As illustrated in FIG. 11, the computer system 1100 may include a processor 1102, e.g., a central processing unit (CPU), a graphics processing unit (GPU), or both. The processor 1102 may be a component in a variety of systems. For example, the processor 1102 may be part of a standard personal computer or a workstation. The processor 1102 may be one or more general processors, digital signal processors, application specific integrated circuits, field programmable gate arrays, servers, networks, digital circuits, analog circuits, combinations thereof, or other now known or later developed devices for analyzing and processing data. The processor 1102 may implement a software program, such as code generated manually (i.e., programmed).

The computer system 1100 may include a memory 1104 that can communicate via a bus 1108. The memory 1104 may be a main memory, a static memory, or a dynamic memory. The memory 1104 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1104 includes a cache or random-access memory for the processor 1102. In alternative implementations, the memory 1104 is separate from the processor 1102, such as a cache memory of a processor, the system memory, or other memory. The memory 1104 may be an external storage device or database for storing data. Examples include a hard drive, compact disc ("CD"), digital video disc ("DVD"), memory card, memory stick, floppy disc, universal serial bus ("USB") memory device, or any other device operative to store data. The memory 1104 is operable to store instructions executable by the processor 1102. The functions, acts or tasks illustrated in the figures or described herein may be performed by the programmed processor 1102 executing the instructions stored in the memory 1104. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 1100 may further include a display 1110, such as a liquid crystal display (LCD), an organic light emitting diode (OLED), a flat panel display, a solid-state display, a cathode ray tube (CRT), a projector, a printer or other now known or later developed display device for outputting determined information. The display 1110 may act as an interface for the user to see the functioning of the processor 1102, or specifically as an interface with the software stored in the memory 1104 or in a drive unit 1106. For example, the display 1110 may be the user interface that displays the actionable recommendations provided by the insights agent.

Additionally or alternatively, the computer system 1100 may include a user input/output device 1112 configured to allow a user to interact with any of the components of system 1100. The user input/output device 1112 may be a number pad, a keyboard, or a cursor control device, such as a mouse, or a joystick, touch screen display, remote control, or any other device operative to interact with the computer system 1100.

The computer system 1100 may also or alternatively include a disk or optical unit as the drive unit 1106. The drive unit 1106 may include a computer-readable medium 1122 in which one or more sets of instructions 1124, e.g., software, can be embedded. Further, the instructions 1124 may embody one or more of the methods or logic as described herein. The instructions 1124 may reside completely or partially within the memory 1104 and/or within the processor 1102 during execution by the computer system 1100. The memory 1104 and the processor 1102 also may include computer-readable media as discussed above.

In some systems, a computer-readable medium 1122 includes instructions 1124 or receives and executes instructions 1124 responsive to a propagated signal so that a device connected to a network 1130 can communicate voice, video, audio, images, or any other data over the network 1130. Further, the instructions 1124 may be transmitted or received over the network 1130 via a communication interface 1120, and/or using a bus 1108. The communication interface 1120 may be a part of the processor 1102 or may be a separate component. The communication interface 1120 may be created in software or may be a physical connection in hardware. The communication interface 1120 may be configured to connect with a network 1130, external media, the display 1110, or any other components in system 1100, or combinations thereof. The connection with the network 1130 may be a physical connection, such as a wired Ethernet connection or may be established wirelessly as discussed below. Likewise, the additional connections with other components of the system 1100 may be physical connections or may be established wirelessly. The network 1130 may alternatively be directly connected to the bus 1108.

While the computer-readable medium 1122 is shown to be a single medium, the term "computer-readable medium" may include a single medium or multiple media, such as a centralized or distributed database, and/or associated caches and servers that store one or more sets of instructions. The term "computer-readable medium" may also include any medium that is capable of storing, encoding, or carrying a set of instructions for execution by a processor or that cause a computer system to perform any one or more of the methods or operations disclosed herein. The computer-readable medium 1122 may be non-transitory, and may be tangible.

The computer-readable medium 1122 can include a solid-state memory such as a memory card or other package that houses one or more non-volatile read-only memories. The computer-readable medium 1122 can be a random-access memory or other volatile re-writable memory. Additionally or alternatively, the computer-readable medium 1122 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 1100 may be connected to one or more networks 1130, such as network(s) 105. The network 1130 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 1130 may include wide area networks (WAN), such as the Internet, local area networks (LAN), campus area networks, metropolitan area networks, a direct connection such as through a Universal Serial Bus (USB) port, or any other networks that may allow for data communication. The network 1130 may be configured to couple one computing device to another computing device to enable communication of data between the devices. The network 1130 may generally be enabled to employ any form of machine-readable media for communicating information from one device to another. The network 1130 may include communication methods by which information may travel between computing devices. The network 1130 may be divided into sub-networks. The sub-networks may allow access to all of the other components connected thereto or the sub-networks may restrict access between the components. The network 1130 may be regarded as a public or private network connection and may include, for example, a virtual private network or an encryption or other security mechanism employed over the public Internet, or the like. The network 1130 may be the network 105, or another network.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for automating software delivery assessment, the method comprising:
receiving, by one or more processors, data from a plurality of software delivery tools, the data comprising information related to at least one of issue tracking, version control, continuous integration and deployment (CI/CD) logs, incident management systems, or static code analysis tools, the received data including data values associated with a set of metrics;
processing, by a processing agent executed by the one or more processors, the received data to validate timestamps, normalize the data values for each metric of the set of metrics, and/or exclude invalid or duplicate data values;
scoring, by a scoring agent executed by the one or more processors, each metric of the set of metrics by comparing the processed data values for each metric to metric-specific scoring criteria; and
generating, by an insights agent executed by the one or more processors, actionable recommendations based on the scored set of metrics.

2. The computer-implemented method of claim 1, wherein the set of metrics comprises metrics related to at least one of deployment frequency, lead time for changes, mean time to restore, change failure rate, cycle time, issue resolution time, code review effectiveness, pipeline success rate, code quality, or test coverage.

3. The computer-implemented method of claim 1, further comprising:
updating, by the one or more processors, scores for at least one metric of the set of metrics and the actionable recommendations over time based on newly collected data from the plurality of software delivery tools.

4. The computer-implemented method of claim 1, wherein the scoring agent maps the normalized data values for each metric of the set of metrics to a corresponding level comprising at least two of a high level, a medium level, or a low level based on predefined thresholds.

5. The computer-implemented method of claim 1, further comprising:
generating, by the insights agent executed by the one or more processors, a report comprising strengths, weaknesses, and the actionable recommendations based on the scored set of metrics.

6. The computer-implemented method of claim 5, further comprising:
updating, by the one or more processors, the report over time based on newly collected data from the plurality of software delivery tools.

7. The computer-implemented method of claim 5, wherein the report includes visualizations of trends over time and benchmark comparisons against industry standards.

8. The computer-implemented method of claim 1, further comprising:
training, by the one or more processors, a machine-learning model using historical metric data, user feedback, and benchmark performance targets to refine scoring accuracy of the scoring of the set of metrics and improve relevance of the actionable recommendations.

9. The computer-implemented method of claim 1, wherein the data is collected by a data collection agent configured to integrate with APIs of at least one of Jira, GitHub, Jenkins, CI/CD pipelines, or static analysis tools.

10. The computer-implemented method of claim 9, further comprising:
coordinating, by a coordinator agent executed by the one or more processors, operations of the data collection agent, the processing agent, the scoring agent, and the insights agent.

11. The computer-implemented method of claim 1, wherein the processing comprises:
applying, by the processing agent, a schema mapping operation that constructs a unified data schema and maps heterogeneous field names and data formats from each of the plurality of software delivery tools to corresponding fields in the unified data schema;
validating timestamps and verifying integrity of the received data values;
detecting and excluding duplicate data values by computing hash values for data records and comparing the hash values against previously stored hash values in a deduplication index;
applying metric-specific normalization functions to scale the data values for each metric to enable comparison across metrics with different native units and value distributions; and
associating additional metadata with the data values or aggregating data over specified time intervals.

12. The computer-implemented method of claim 1, wherein the scoring comprises:
generating, by the scoring agent, an individual metric score for each metric of the set of metrics;
constructing a multi-dimensional key performance indicator (KPI) vector for a given assessment period, wherein each dimension of the KPI vector corresponds to a normalized score for a respective metric of the set of metrics;
accumulating a time series of KPI vectors across a plurality of assessment periods;
applying a clustering algorithm to the time series of KPI vectors to partition the KPI vectors into a set of clusters, each cluster representing a distinct maturity profile;
computing a centroid for each cluster representing a signature pattern and a frequency value representing a proportion of KPI vectors assigned to the cluster;
assigning the given assessment period's KPI vector to a nearest cluster and outputting a corresponding maturity label; and
computing a composite maturity score based on a weighted aggregation of the individual metric scores.

13. The computer-implemented method of claim 1, wherein the generating of the actionable recommendations comprises:
receiving, by the insights agent, scored metric data and time series data from the scoring agent;
computing a pairwise correlation matrix across the scored set of metrics for a defined historical window;
identifying correlated metric pairs having a correlation coefficient exceeding a predefined correlation threshold;
applying a trend detection algorithm to the time series data to detect at least one of an upward trend, a downward trend, or an anomaly for each metric;
mapping combinations of the scored set of metrics, detected trends, and identified correlated metric pairs to a library of recommendation templates using a rule engine;
populating matching recommendation templates with metric-specific values to generate the actionable recommendations; and
ranking the actionable recommendations by a priority score based on at least one of a severity of an identified maturity gap, an estimated impact on a composite maturity score, or a confidence level of an underlying trend or correlation detection.

14. The computer-implemented method of claim 1, further comprising:
receiving, by the one or more processors, an actionable recommendation generated by the insights agent based on the scored set of metrics;
evaluating a corrective action associated with the actionable recommendation to determine whether the corrective action is subject to a user-configurable approval policy;
transmitting a control signal to one or more of the plurality of software delivery tools via an API integration to modify one or more configuration parameters of the one or more of the plurality of software delivery tools based on the corrective action;
monitoring an effect of the corrective action on the scored set of metrics over a defined observation period; and
evaluating an outcome of the corrective action by determining whether the scored set of metrics has improved, remained unchanged, or declined following the corrective action.

15. A system for automating software delivery assessment, the system comprising:
a memory storing instructions and one or more AI agents; and
one or more processors operatively connected to the memory and configured to execute the instructions to perform operations including:
receiving data from a plurality of software delivery tools, the data comprising information related to at least one of issue tracking, version control, continuous integration and deployment (CI/CD) logs, incident management systems, or static code analysis tools, the received data including data values associated with a set of metrics;
processing, by a processing AI agent of the one or more AI agents, the received data to validate timestamps, normalize the data values for each metric of the set of metrics, and/or exclude invalid or duplicate data values;
scoring, by a scoring AI agent of the one or more AI agents, each metric of the set of metrics by comparing the processed data values for each metric to metric-specific scoring criteria; and
generating, by an insights AI agent of the one or more AI agents, actionable recommendations based on the scored set of metrics.

16. The system of claim 15, wherein the system supports real-time updates and is deployed as a cloud-based service.

17. The system of claim 15, wherein the system is configured to receive user feedback on accuracy and usefulness of the actionable recommendations.

18. The system of claim 17, the one or more processors operatively connected to the memory and configured to execute the instructions to perform the operations further including:
training a machine-learning model using at least one of historical metric data, the user feedback, or benchmark performance targets to refine scoring accuracy of the scoring of the set of metrics and improve relevance of the actionable recommendations.

19. The system of claim 18, wherein the machine-learning model automatically updates scoring and insight generation algorithms, based on at least one of the historical metric data, the user feedback, or the benchmark performance targets, utilized by the one or more AI agents to refine the scoring accuracy and improve the relevance.

20. A non-transitory machine-readable medium storing instructions that, when executed by one or more processors, cause a multi-agent generative AI system to perform a method for automating software delivery assessment, the method comprising:
receiving data from a plurality of software delivery tools, the data comprising information related to at least one of issue tracking, version control, continuous integration and deployment (CI/CD) logs, incident management systems, or static code analysis tools, the received data including data values associated with a set of metrics;
processing, by a processing agent, the received data to validate timestamps, normalize the data values for each metric of the set of metrics, and/or exclude invalid or duplicate data values;
scoring, by a scoring AI agent, each metric of the set of metrics by comparing the processed data values for each metric to metric-specific scoring criteria; and
generating, by an insights AI agent, actionable recommendations based on the scored set of metrics.
